(19) United States
(12) Patent Application Publication
(10) Pub. No.: US 2017/0063203 A1
(43) Pub. Date: Mar. 2, 2017

(54) Inverter Assembly

(71) Applicant: Faraday&Future Inc., Gardena, CA (US)

(72) Inventor: Young Mok Doo, La Palma, CA (US)

(21) Appl. No.: 15/015,102

(22) Filed: Feb. 3, 2016

Related U.S. Application Data
(63) Continuation-in-part of application No. 14/952,829, filed on Nov. 25, 2015.
Application No. 14/952,829 is a continuation of application No. 14/841,520, filed on Aug. 31, 2015, now Pat. No. 9,241,428.

(51) Int. Cl. H02K 11/04; H02K 11/22

(52) U.S. Cl. CPC H02K 11/044; H02K 11/022

(57) ABSTRACT

Power inverter assemblies provided herein may comprise: a conductive metal structure connecting the inverter assembly to a motor assembly, containing an inverter, physically protecting the inverter from an external environment, shielding at least some components of the inverter from electromagnetic interference, and providing an electrical ground to one or more components of the inverter; and the inverter comprising: a first DC link capacitor; a second DC link capacitor; a capacitor enclosure, the first DC link capacitor and the second DC link capacitor being potted on a sidewall of the capacitor enclosure; a plurality of power modules electrically coupled with the both the first DC link capacitor and the second DC link capacitor; and an AC bus bar assembly coupled to the plurality of power modules, the AC bus bar assembly providing output current produced by the plurality of power modules.

### CROSS-REFERENCE TO RELATED APPLICATIONS

This application is a continuation-in-part of U.S. patent application Ser. No. 14/952,829, filed Nov. 25, 2015, which is a continuation of U.S. patent application Ser. No. 14/841,520, filed Aug. 31, 2015 (now U.S. Pat. No. 9,241,428, issued on Jan. 19, 2016), the disclosures of which are hereby incorporated by reference for all purposes.

This application is related to U.S. patent application Ser. No. 14/841,526, filed Aug. 31, 2015, titled “Inverter DC Bus Bar Assembly,” and U.S. patent application Ser. No. 14/841,532, filed Aug. 31, 2015, titled “Inverter AC Bus Bar Assembly,” both of which are hereby incorporated by reference for all purposes.

### FIELD OF THE PRESENT DISCLOSURE

The present disclosure relates generally to an inverter assembly and, more specifically, but not by limitation, to an inverter assembly comprising structures configured to convert a DC input to a three phase AC output.

### SUMMARY OF THE PRESENT DISCLOSURE

According to various embodiments, the present disclosure may be directed to an inverter assembly, comprising: a conductive metal structure connecting the inverter assembly to a motor assembly, containing an inverter, physically protecting the inverter from an external environment, shielding at least some components of the inverter from electromagnetic interference, and providing an electrical ground to one or more components of the inverter; and the inverter comprising: a first DC link capacitor; a second DC link capacitor; a capacitor enclosure, the first DC link capacitor and the second DC link capacitor being potted on a sidewall of the capacitor enclosure; a plurality of power modules electrically coupled with the both the first DC link capacitor and the second DC link capacitor; and an AC bus bar assembly coupled to the plurality of power modules, the AC bus bar assembly providing output current produced by the plurality of power modules.

### BRIEF DESCRIPTION OF THE DRAWINGS

Certain embodiments of the present disclosure are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a perspective view of an exemplary drive train that comprises inverter assemblies of the present disclosure.

FIG. 2 is a perspective view of an exemplary inverter assembly.

FIG. 3 is an exploded perspective view of the exemplary inverter assembly of FIG. 2.

FIG. 4 is a top down view of the exemplary inverter assembly with a top cover removed.

FIGS. 5A, 5B, and 5C are various views of an exemplary DC bus bar sub-assembly.

FIG. 6 is a perspective view of a portion of another exemplary DC bus bar sub-assembly.

FIG. 7 is a perspective view of the exemplary DC bus bar sub-assembly connected to power cables.

FIG. 8 is a top elevation view that illustrates an exemplary DC link capacitor of the inverter assembly, where the DC link capacitor may comprise a capacitor bank.

FIG. 9A is a perspective view of an exemplary DC input bus bar that couples the DC link capacitor with power modules.

FIG. 9B is an exploded perspective view of another the DC input bus bar of FIG. 9A.

FIG. 9C is a cross sectional view of the exemplary DC input bus bar of FIGS. 9A and 9B.

FIG. 10 is a perspective view of the exemplary DC input bus bar installed into the inverter assembly.

FIG. 11 is a partial exploded perspective view of exemplary power modules.

FIG. 12 is a perspective view of an exemplary three phase output AC bus bar sub-assembly.

FIG. 13 is another perspective view of the exemplary three phase output AC bus bar sub-assembly.

FIG. 14 is a perspective view of exemplary three bus bars of the three phase output AC bus bar sub-assembly.

FIG. 15 is a top down view of the exemplary three phase output AC bus bar sub-assembly installed into the inverter assembly.

FIG. 16 is a perspective view of the exemplary three phase output AC bus bar sub-assembly coupled with power cables.

FIG. 17 is an exploded view of an exemplary cooling assembly.

FIGS. 18A-C illustrate an exemplary alternative cooling assembly.

FIG. 19 is a perspective view that illustrates another example inverter assembly.

FIG. 20A is a perspective view of an example first portion of the inverter assembly.

FIG. 20B is a perspective view of an example second portion of the inverter assembly.

FIG. 21 is a top plan view of the example inverter assembly.

FIG. 22 is a bottom plan view of FIG. 19, according to various embodiments.

FIG. 23 is a side elevation view of the example inverter assembly.

FIG. 24A is a top down view of an example three phase AC bus bar of the example inverter assembly.

FIG. 24B is a perspective view of the example three phase AC bus bar.

FIG. 25 is a rear elevation view of the example inverter assembly.

FIG. 26 is a side elevation view of the example inverter assembly, illustrating an opposing side relative to FIG. 23.

FIG. 27 is a perspective view of a DC input filter of the example inverter assembly.

FIG. 28 is a perspective view of the example inverter assembly of FIG. 19 in combination with a motor housing.

FIG. 29 is another perspective view of the example inverter assembly of FIG. 19 in combination with a motor housing, illustrating a location of the output tabs of a three phase output AC bus bar sub-assembly.

FIGS. 30-33 illustrate various views of example inverter assemblies, constructed in accordance with the present disclosure

FIGS. 34 and 35A-D illustrate other views of example inverter assemblies, constructed in accordance with the present disclosure.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the present disclosure. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

In general, the present disclosure is directed to inverter assemblies and their methods of manufacture and use. An example inverter assembly comprises a symmetrical structure configured to convert DC input power to AC output power.

Some embodiments includes a symmetrical DC input section, a symmetrical AC output section, a gate drive circuit board, and a controller. The gate drive circuit board and controller can be associated with two inverter power modules coupled in parallel. The power modules can provide currents significantly exceeding 400 amps RMS (root mean squared) and in various embodiments, each can comprise an IGBT (insulated gate bipolar transistor), or other suitable element, for switching the direct current into an alternating current. The total RMS current may exceed that which may be typically available by a single commercially available power module. The DC input section can include a DC input bus and a DC bus sub-assembly. The DC bus sub-assembly can have a symmetrical structure with a layered design, including a positive plate and a negative plate substantially overlapping each other. The positive plate can be coupled to the positive terminal of the DC input bus through a plurality of positive input tabs. The negative plate can be coupled to the negative terminal of the DC input bus through a plurality of negative input tabs. The positive plate can have two or more positive output tabs and two or more negative output tabs coupled to the input terminals of the two inverter power modules.

The AC output section includes a plurality of output bus bars, each having a symmetrical structure. In an embodiment, the AC output section provides a three-phase AC power signal. Each of the output bus bars corresponds to a channel (phase) of the three-phase AC power signal. Each of the output bus bar includes two input tabs coupled to output terminals of each channel of the two inverter power modules and an output tab coupled to an AC output terminal of the inverter. The output tab may be disposed at substantial equal distances from the two input tabs of each AC bus bar. These and other advantages of the present disclosure will be described in greater detail infra with reference to the collective drawings.

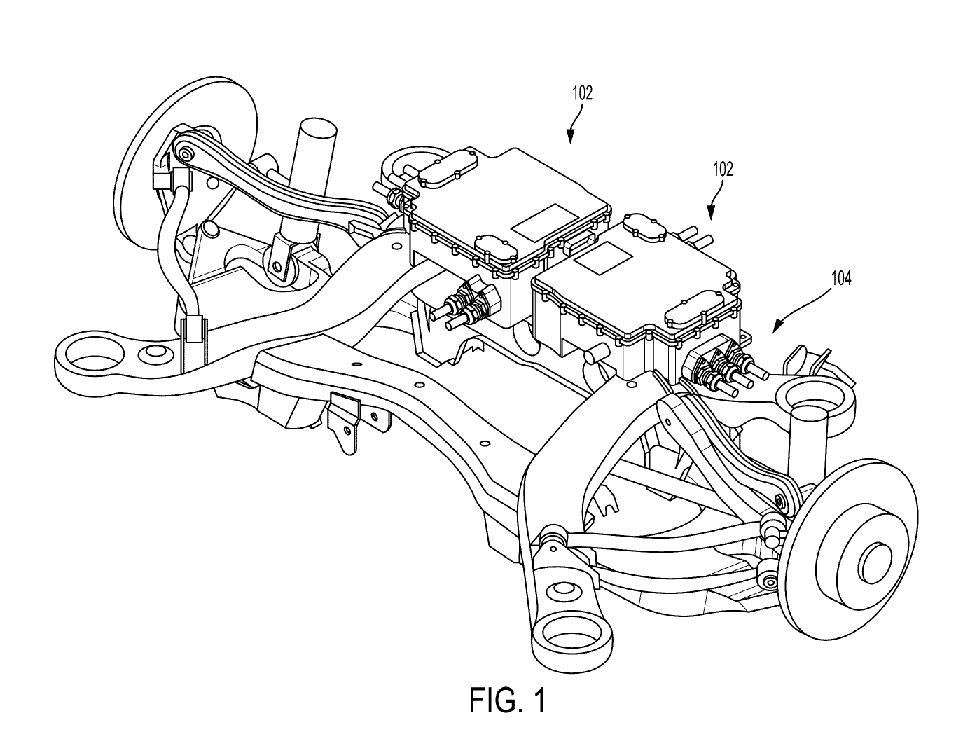

Referring now to FIG. 1, which illustrates the positioning of two inverter assemblies, such as exemplary inverter assembly 102. The inverter assemblies are disposed on an exemplary drive train 104.

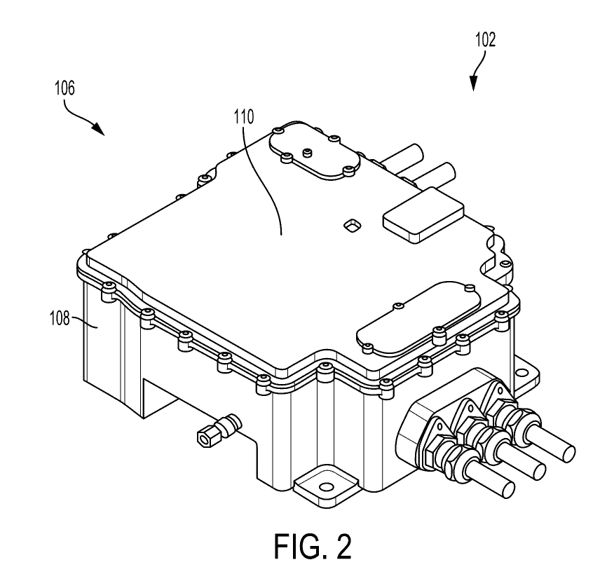

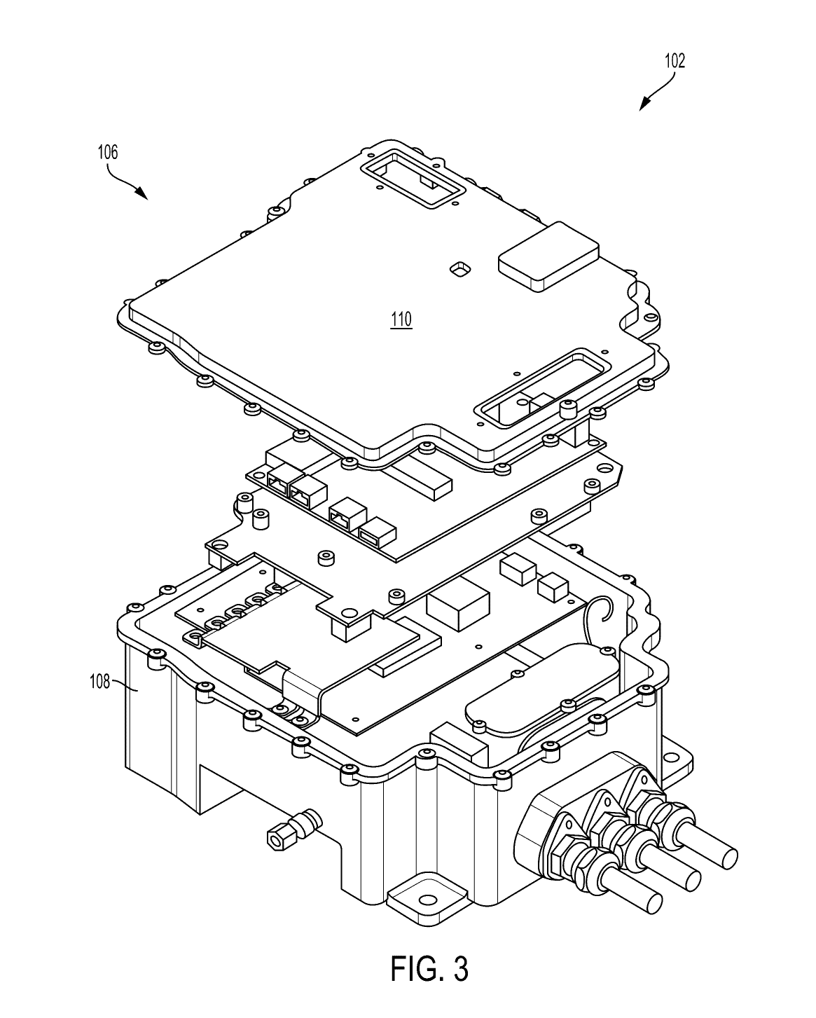

FIGS. 2 and 3 collectively illustrate the exemplary inverter assembly 102 which comprises a housing 106 that comprises a lower enclosure 108 and a cover 110.

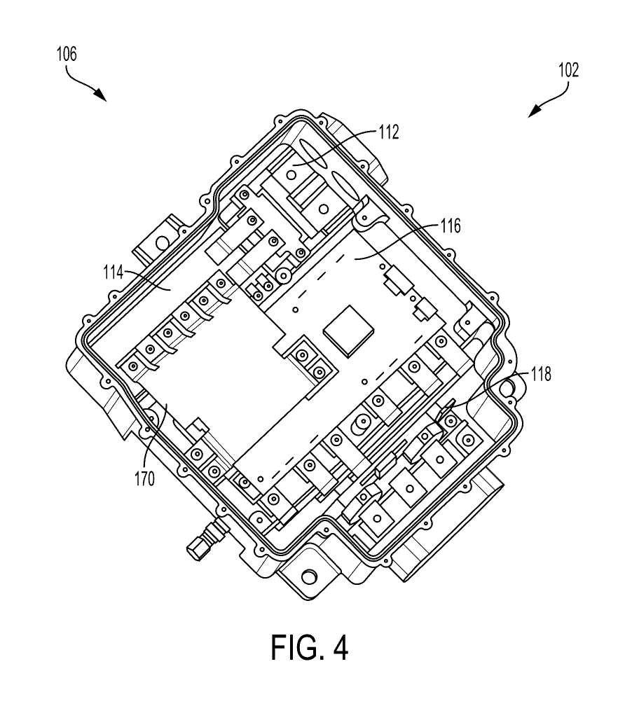

FIG. 4 is a top down view of the exemplary inverter assembly 102 with the cover 110 removed to expose internal components of the inverter assembly 102. In some embodiments, the inverter assembly 102 comprises a DC bus sub-assembly (referred to herein as “DC bus bar 112”), a DC link capacitor 114 (which may comprise a capacitor bank and also be referred to as DC link capacitor bank 114), a DC input bus bar sub-assembly 170, a gate drive circuit board 116, and a three phase output AC bus bar sub-assembly 118.

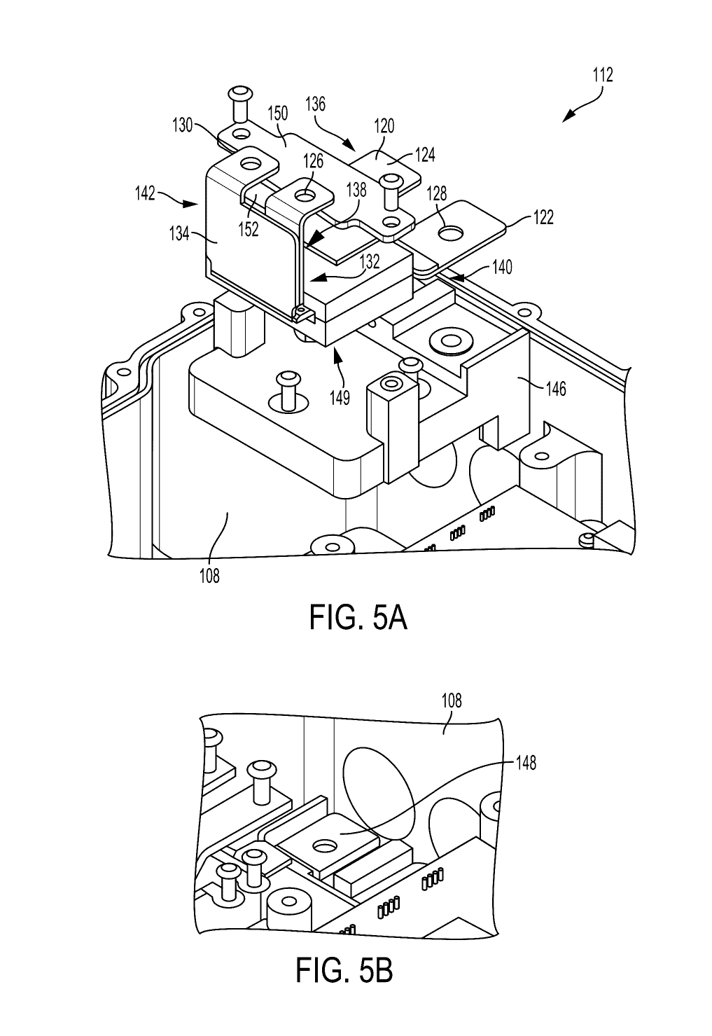

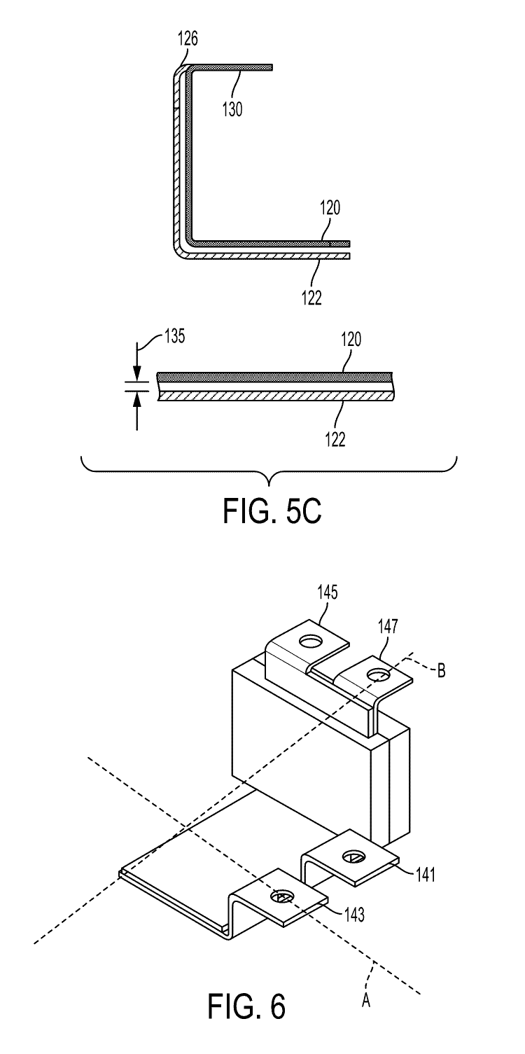

FIGS. 5A-C collectively illustrate the example DC bus bar 112 that comprises a pair of bus bars, namely a positive bus bar 120 and a negative bus bar 122. Each of the bus bars comprises an input tab and an output tab. For example, the positive bus bar 120 may comprise a positive input tab 124 and a positive output tab 126, while the negative bus bar 122 may comprise a negative input tab 128 and a negative output tab 130.

Both the positive bus bar 120 and the negative bus bar 122 have a bar body that spans between their respective input tab and output tab. In one embodiment, the positive bus bar 120 has a positive bar body 132 and the negative bus bar 122 comprises a negative bar body 134.

In some embodiments, the positive bus bar 120 and the negative bus bar 122 are shaped similarly to one another. Both the positive bus bar 120 and negative bus bar 122 have a first section and a second section. For example, the positive bus bar 120 has a first section 136 and a second section 138. In some embodiments, the first section 136 and the second section 138 are positioned relative to one another at a substantially right angle configuration. That is, the first section 136 extends perpendicularly from the second section 138.

The negative bus bar 122 comprises a first section 140 and a second section 142. In some embodiments, the first section 140 and second section 142 are positioned relative to one another at a substantially right angle.

The input tabs on both the positive bus bar 120 and the negative bus bar 122 extend from their respective bar body. For example, the positive input tab 124 extends in linear alignment with the first section 136 of the positive bar body 132. The positive output tab 126 extends rearwardly from the second section 138 of the positive bus bar 120.

The positive bus bar 120 and the negative bus bar 122 are placed into mating relationship with one another such that the positive bus bar 120 may be nested within the negative bus bar 122 with both being electrically isolated from one another. A space exists between the positive bar body 132 and the negative bar body 134. The size of this space can be minimized, which reduces inductance through the DC bus bar 112 and minimizes noise pick-up from stray fields within the inverter enclosure.

In one embodiment, the negative output tab 130 of the negative bus bar 122 may be offset to a side of the second section 142 of the negative bar body 134. Conversely, the positive output tab 126 of the positive bus bar 120 may be offset to a side of the second section 138 of the positive bar body 132. In one embodiment, the negative output tab 130 and the positive output tab 126 are spaced apart from one another due to their positioning on their respective sides of their associated bar body. Similarly, the positive input tab 124 and the negative input tab 128 are spaced apart from one another and can be individually secured to a terminal block, which is described in greater detail below.

In some embodiments, the space between the positive bar body 132 and the negative bar body 134 can be filled with an electrical insulator such as a Mylar™ film. Likewise, surfaces of the positive bar body 132 and the negative bar body 134 that face one another can be coated with a layer of an electrically insulating material rather than disposing an electrically insulating layer therebetween.

In some embodiments, the first section 136 of positive bar body 132 and the first section 140 of the negative bar body 134 are surrounded, at least partially, with an input core 149. The input core 149 may be configured to contact a terminal block 146 onto which the pair of bus bars are installed.

For example, the terminal block 146 provides a mounting surface that supports the DC bus bar 112. The terminal block 146 can mount to the inner sidewall of the lower enclosure 108 and a lower support 148 of the lower enclosure 108.

In some embodiments, the input core 149 may be secured to the terminal block 146 using a compression plate 150. A spacer 152 can be disposed between the input core 149 and the compression plate 150. In one embodiment, the spacer 152 may be a silicon foam block, although other materials that would be known to one of ordinary skill in the art can also likewise be utilized in accordance with the present disclosure.

Another example of a DC bus bar 112 is illustrated in FIG. 6. In this embodiment, the input tabs 141 and 143 angle upwardly and outwardly from the bar bodies along reference line A, rather than in linear alignment. Also, the input tabs 141 and 143 can extend from a side edge of the bar bodies, while output tabs 145 and 147 can extend in alignment with reference line B. To be sure, reference line A and reference line B can be substantially perpendicular to one another.

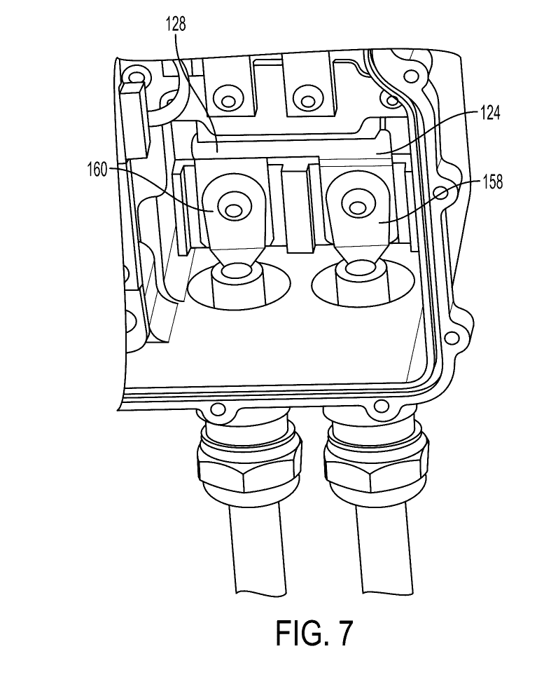

Turning to FIG. 7, the positive input tab 124 and negative input tab 128 are illustrated as being coupled with input power cables 158 and 160, respectively.

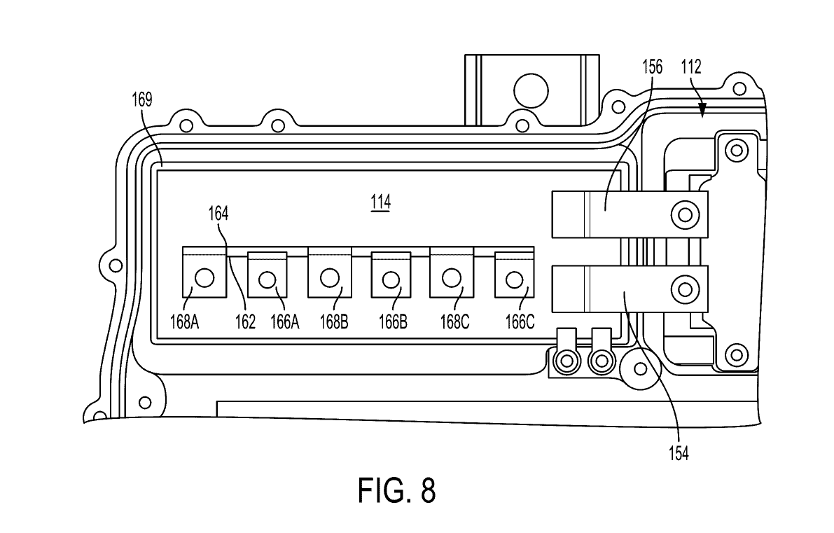

FIG. 8 is a top elevation view that illustrates the exemplary DC link capacitor 114 of the inverter assembly, where the DC link capacitor may comprise a capacitor bank. As illustrated in FIG. 8, in some embodiments, the DC bus bar 112 may be electrically coupled to the DC link capacitor 114 through a first connector 154 and a second connector 156. (The first connector 154 and the second connector 156 may variously be positive and negative connectors depending on the arrangement of the polarities provided by the DC bus bar 112.) According to some embodiments, the first connector 154 and second connector 156 are coupled or embedded within the DC link capacitor 114. To be sure, the DC link capacitor 114 can be potted into place within the lower enclosure 108; the first connector 154 and second connector 156 being embedded into the DC link capacitor 114 during the potting process.

Additionally, a positive output bus bar 162 may be embedded into the DC link capacitor 114, along with a negative output bus bar 164. Both the positive output bus bar 162 and the negative output bus bar 164 comprise a plurality of output tabs. For example, the positive output bus bar 162 comprises positive output tabs 166A-C, while negative output bus bar 164 comprises negative output tabs 168A-C. In some embodiments, the positive output tabs 166A-C and the negative output tabs 168A-C are positioned in linear alignment with one another. The positive output tabs 166A-C and the negative output tabs 168A-C can also be alternatingly positioned such that negative output tab 168A may be positioned between positive output tab 166A and positive output tab 166B, just as an example.

The DC link capacitor 114 can be potted into a void 169, in some instances. In one embodiment, the DC link capacitor 114 is secured within the void 169 with a potting material that can include a mixture of polyol and isocyanate. The potting material can include 100 parts polyol to 20 parts isocyanate, in some embodiments. The DC link capacitor material may be poured into the void 169 to a height of 45 to 50 mm below an upper edge of the void 169. The DC link capacitor material can be cured at 25 degrees centigrade for 24 hours, at 60 degrees centigrade for two hours, or also at 100 degrees centigrade for 20-30 minutes, in various embodiments.

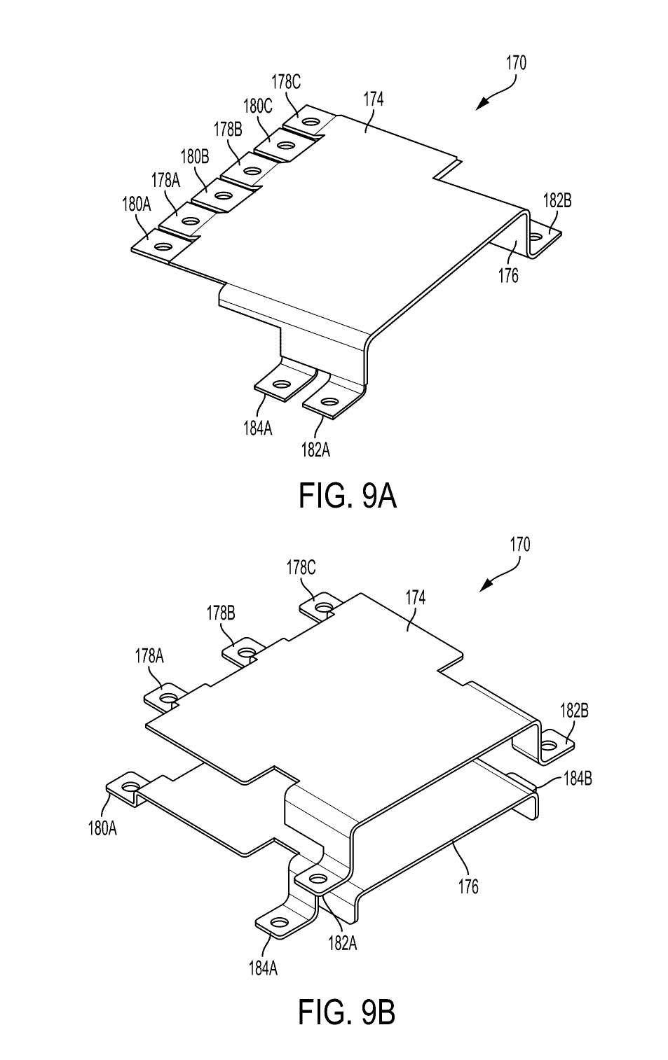

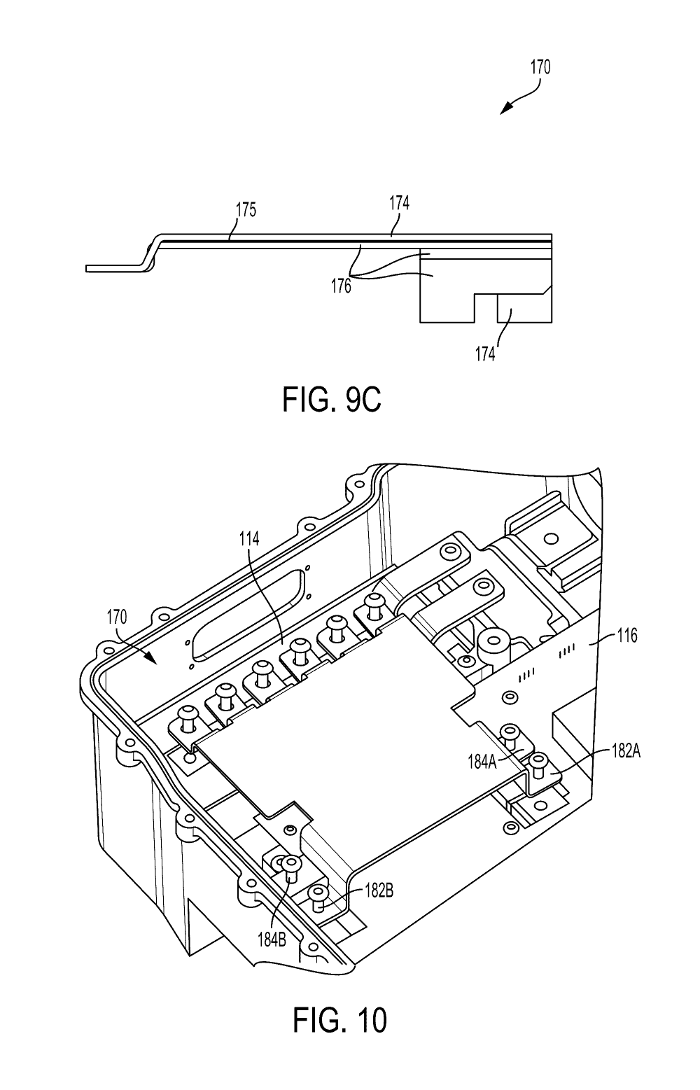

Referring now to FIGS. 9A-10, which illustrate an example DC input bus bar sub-assembly 170. The DC input bus bar sub-assembly 170 can also be referred to as a “second DC bus bar sub-assembly” or “DC input bus bar 170”. The DC input bus bar 170 comprises a positive bus bar 174 and a negative bus bar 176, which are arranged into a mating relationship with one another similarly to the DC bus bar 112 described above.

The positive bus bar 174 comprises a plurality of positive input tabs 178A-C and the negative bus bar 176 comprises a plurality of negative input tabs 180A-C. When installed, the positive bus bar 174 couples with the positive output bus bar 162 of the DC link capacitor 114 by connecting the plurality of positive input tabs 178A-C of the positive bus bar 174 with the positive output tabs 166A-C of the positive output bus bar 162 of the DC link capacitor 114. Likewise, the negative bus bar 176 couples with the negative output bus bar 164 of the DC link capacitor 114 by connecting the plurality of negative input tabs 180A-C of the negative bus bar 176 with the negative output tabs 168A-C of the negative output bus bar 164 of the DC link capacitor 114.

The plurality of positive input tabs 178A-C and the plurality of negative input tabs 180A-C are arranged in an alternating and linear configuration.

The positive bus bar 174 and negative bus bar 176 are placed in an overlaid mating relationship with one another. A space 175 may be provided between the positive bus bar 174 and negative bus bar 176, which can be filled with an electrically insulating material, in some embodiments. The space 175 between the positive bus bar 174 and negative bus bar 176 allows for low inductance of current through the DC input bus bar sub-assembly 170.

The positive bus bar 174 comprises a pair of positive output tabs 182A and 182B, while the negative bus bar 176 comprises a pair of negative output tabs 184A (shown in FIG. 10) and 184B. The pair of positive output tabs 182A and 182B are disposed on opposing sides of the positive bus bar 174 relative to one another. The pair of negative output tabs 184A and 184B are also disposed on opposing sides of the negative bus bar 176 relative to one another. The pairs of negative and positive output tabs are arranged such that positive output tab 182A may be placed in proximity to negative output tab 184A, while positive output tab 182B may be placed in proximity to negative output tab 184B.

As illustrated best in FIG. 10, the DC input bus bar 170 provides electrical connectivity between the DC link capacitor 114 and the power modules of the gate drive circuit board 116, which will be described in greater detail below. In one embodiment, the positive output tab 182A and negative output tab 184A are coupled, through an opening in the gate drive circuit board 116, to a first power module 188. The positive output tab 182B and negative output tab 184B are coupled to a second power module 186.

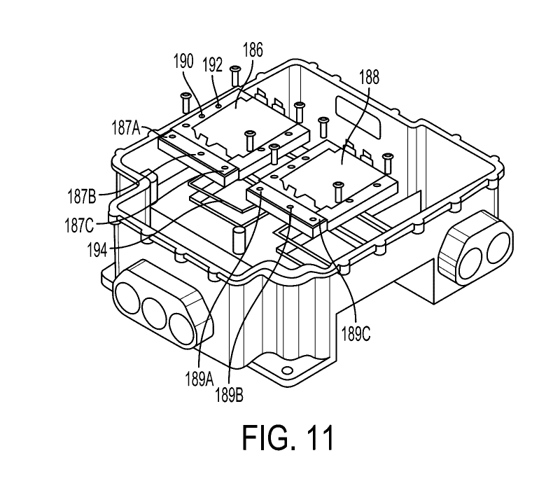

FIG. 11 is a partial exploded perspective view illustrating exemplary first and second power modules 186 and 188, with the gate drive circuit board removed, as well as the various bus bars and the DC link capacitor described above. Each of the first and second power modules 186 and 188 comprises a pair of positive and negative input terminals. For example, first power module 186 includes a positive terminal 190 and a negative terminal 192. Each of the power modules are coupled to a bottom of the lower enclosure 108 with a gasket, such as gasket 194. In various embodiments, the gaskets serve to create a fluid impermeable seal that keeps fluid from a cooling sub-assembly from entering the lower enclosure 108. As will be discussed in greater detail herein, heat sinks of the power modules 186 and 188 are exposed to a coolant fluid by the cooling sub-assembly. The coolant fluid can remove excess heat from the power modules increasing their performance.

Each of the exemplary power modules 186 and 188 comprise three output terminals that each output a different phase of an AC power signal generated by the power module. For example, first power module 186 comprises output terminals 187A, 187B, and 187C and second power module 188 comprises output terminals 189A, 189B, and 189C.

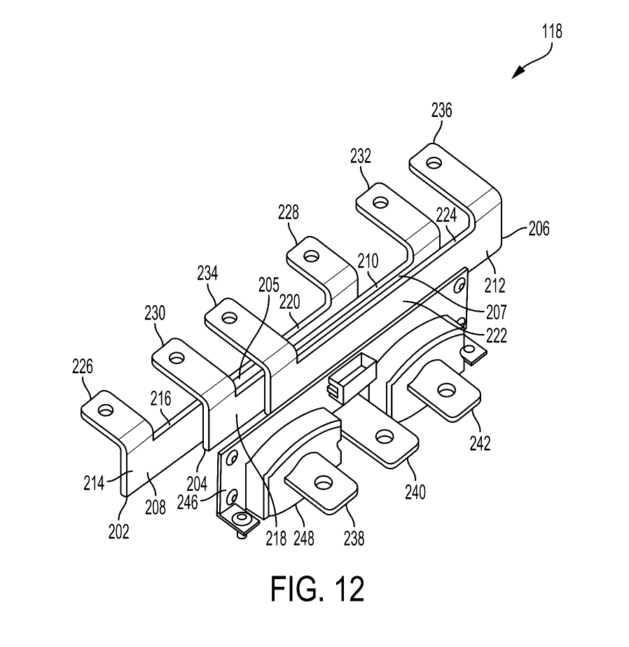

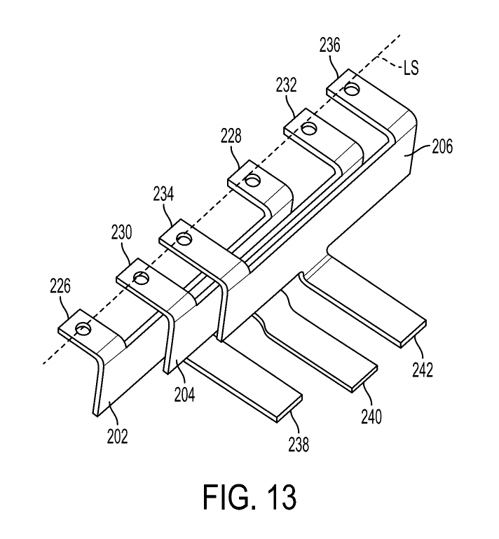

FIGS. 12 and 13 collectively illustrate an example three phase output AC bus bar sub-assembly (hereinafter “AC bus bar 118”). In some embodiments, the AC bus bar 118 comprises three bus bars such as a first bus bar 202, a second bus bar 204, and a third bus bar 206.

Each of the first, second and third bus bars 202, 204, 206 comprises a bar body. For example, first bus bar 202 comprises a bar body 208, the second bus bar 204 comprises a bar body 210, and the third bus bar 206 comprises a bar body 212. Each of the first, second and third bus bars 202, 204, 206 comprises a front and back surface. For example, the bar body 208 of the first bus bar 202 comprises a front surface 214 and a back surface 216. The bar body 210 of the second bus bar 204 comprises a front surface 218 and a back surface 220, while the bar body 212 of the third bus bar 206 comprises a front surface 222 and a back surface 224.

In one embodiment, the first, second and third bus bars 202, 204, 206 are spaced apart from one another while being positioned in a nested configuration. Thus, a space 205 exists between the front surface 214 of the first bus bar 202 and the back surface 216 of the second bus bar 204. Likewise, the third and second bus bars 204, 206 are spaced apart from one another to form a space 207 between the front surface 214 of the second bus bar 204 and the back surface 220 of the third bus bar 206. The spaces 205 and 207 can each be filled with an electrically insulating material. In other embodiments, the front and/or back surfaces of the bus bars 202, 204, 206 can be coated with an insulating layer of material that can be adapted to provide electrical insulation.

Each of the first, second and third bus bars 202, 204, 206 also comprise a plurality of power module tabs that electrically couple each of the bus bars with both the first and second power modules 186 and 188 (see FIG. 11). For example, the first bus bar 202 comprises power module tabs 226 and 228, while the second bus bar 204 comprises power module tabs 230 and 232. The third bus bar 206 comprises power module tabs 234 and 236. The power module tabs of any one of the bus bars are spaced apart from one another so as to allow for the bus bar to connect with each of the power modules.

The plurality of power module tabs of each of the bus bars extend away from the back surface of their respective bar body. The plurality of power module tabs 226, 228, 230, 232, 234, and 236, are coplanar and aligned with one another along a longitudinal axis of alignment Ls (see FIG. 13).

In some embodiments, the first, second and third bus bars 202, 204, 206 are placed into a nested but offset relationship with one another. For example, the second bus bar 204 can be disposed in front of the first bus bar 202, while the third bus bar 206 can be disposed in front of the second bus bar 204. Also, the bus bars are staggered or offset from one another. The second bus bar 204 can be offset from the first bus bar 202, and the third bus bar 206 can be offset from the second bus bar 204. In this configuration, the power module tab 230 of the second bus bar 204 can be positioned between the power module tab 226 of the first bus bar 202 and the power module tab 234 of the third bus bar 206. The power module tab 234 of the third bus bar 206 can be positioned between the power module tab 230 of the second bus bar 204 and the power module tab 228 of the first bus bar 202. The power module tab 228 of the first bus bar 202 may be positioned between the power module tab 234 of the third bus bar 206 and the power module tab 232 of the second bus bar 204. The power module tab 232 may be positioned between the power module tab 228 of the first bus bar 202 and the power module tab 236 of the third bus bar 206.

In some embodiments, a length of the power module tabs (234, 236) of the third 206 of the three bus bars may be greater than a length of the power module tabs (230, 232) of the second 204 of the three bus bars. Also, the length of the power module tabs (230, 232) of the second 204 of the three bus bars can be greater than a length of the power module tabs (226, 228) of the first 202 of the three bus bars.

Each of the first, second and third bus bars 202, 204, and 206 also comprises an output tab, which extends from a front surface of their respective bar body. For example, the first bus bar 202 comprises an output tab 238, the second bus bar 204 comprises an output tab 240, and the third bus bar 206 comprises an output tab 242.

In one embodiment, the output tabs 238, 240, and 242 are arranged so as to be symmetrical in their positioning relative to one another. Due to spacing of the output terminals of each of the power modules (described above), and in order to maintain symmetry of the output tabs 238, 240, and 242, output tab 240 has a substantially serpentine shaped section 244 that positions the output tab 240 in between output tabs 238 and 242.

In some embodiments, the bus bars 202, 204, 206 are held in their respective positions using a mounting plate 246 (see FIG. 12). The mounting plate 246 may be adapted with apertures. The output tabs 238, 240, and 242 each extend through these apertures. In one embodiment, the output tabs 238, 240, and 242 are secured in place on the mounting plate 246 with locking members, such as locking member 248.

The mounting plate 246 can be coupled to the second and the third of the three bus bars 204, 206 (see example shown in FIG. 12).

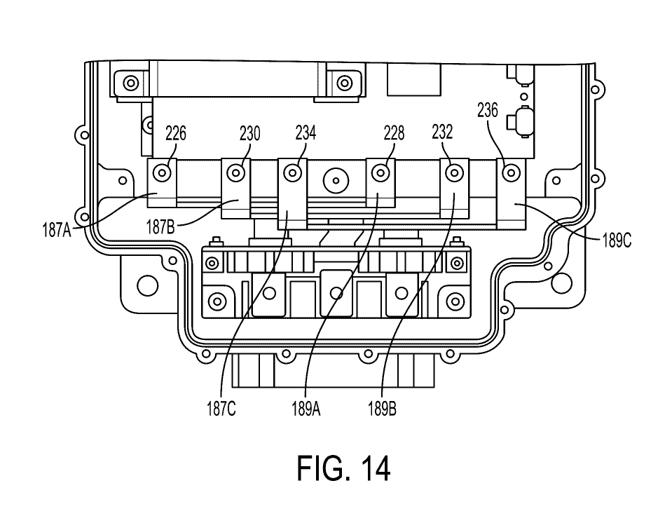

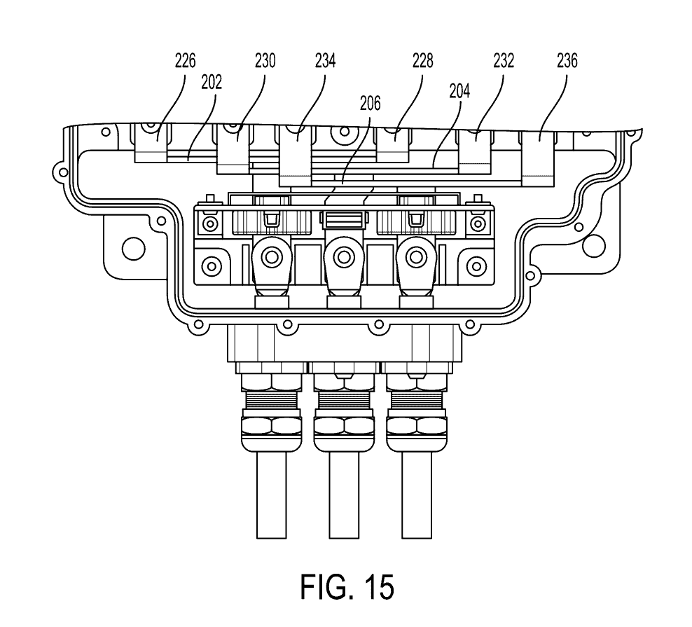

Referring now to FIGS. 14 and 15 (and FIGS. 11, 12, and 13), according to some embodiments, power module tabs 226 and 228 of the first bus bar 202 (see FIG. 12) can connect with output terminal 187A (see also FIG. 11) of first power module 186 and output terminal 189A of second power module 188. The second bus bar 204 may connect with output terminal 187B of first power module 186 and output terminal 189B of second power module 188. The third bus bar 206 can couple with output terminal 187C of first power module 186 and output terminal 189C of second power module 188.

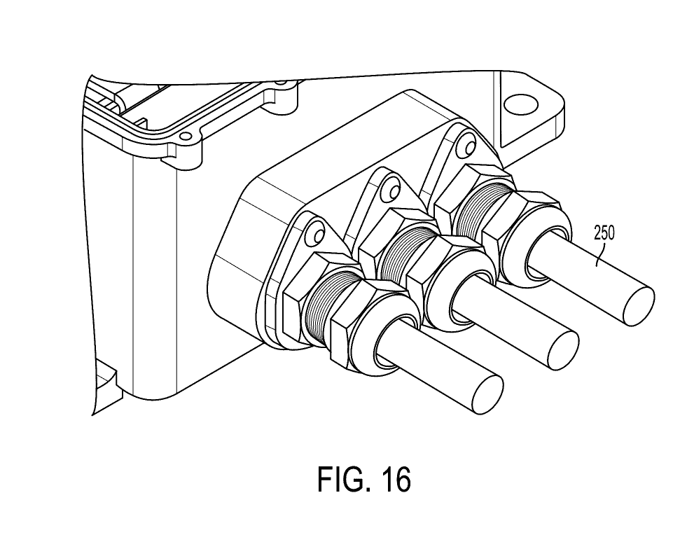

In FIG. 16, a plurality of power cables, such as power cable 250 are coupled with the output tabs 238, 240, and 242 (see FIGS. 14-15) of the AC bus bar 118.

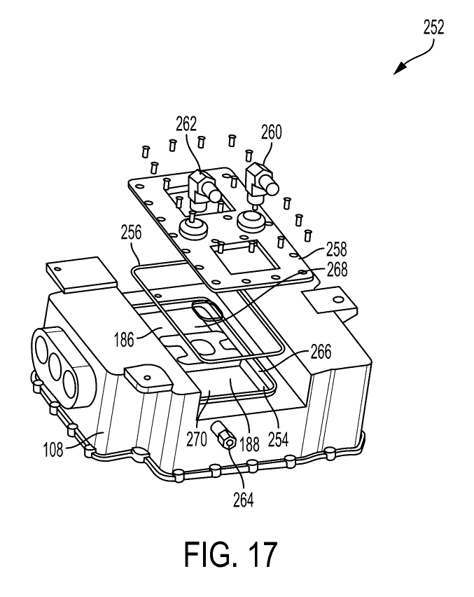

FIG. 17 illustrates an example cooling sub-assembly 252 that comprises a cooling cavity 254, a gasket 256, a cover plate 258, an inlet port 260, an outlet port 262, and a purge port 264. In general, the cooling cavity 254 may be formed by a sidewall 266 formed into a lower enclosure 108 of the housing. Heat sinks 268 and 270 of the power modules 186 and 188, respectively, are exposed to the cooling cavity 254. As mentioned above, the power modules 186 and 188 are isolated with gaskets so as to prevent fluid inside the cooling cavity 254 from entering the housing.

When the cover plate 258 may be joined to the lower enclosure 108 of the housing, a fluid, such as a coolant can be pumped into the cooling cavity 254 through the inlet port 260 and extracted through the outlet port 262 using a pump (not shown). The purge port 264 can be used to purge trapped air from the cooling cavity 254 if needed.

In one embodiment, the inlet and outlet ports 260 and 262 are disposed near a center of the housing which helps promote equal flow rate of fluid to each cooling cavity.

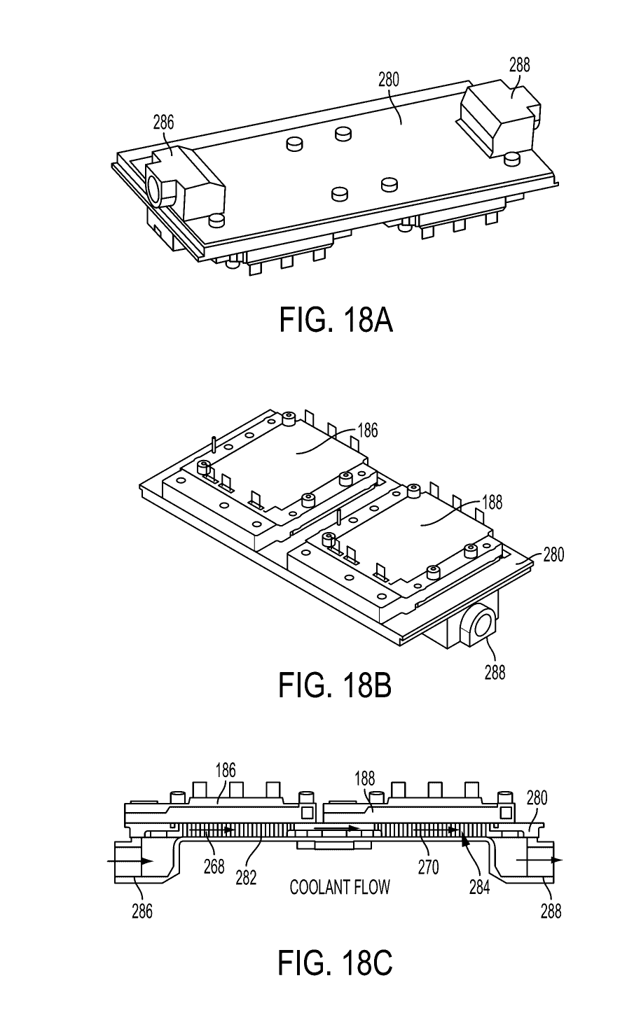

FIGS. 18A-C collectively illustrate another embodiment of a cooling sub-assembly. In one embodiment, the first and second power modules 186 and 188 are mounted to a plate 280. A sidewall (See e.g., 266 in FIG. 17) defines a cooling cavity (See e.g., 254 in FIG. 17). The heat sinks 268 and 270 are positioned within the cooling cavity 254. An inlet port 286 may be positioned on one end of the cooling cavity 254 and an outlet port 288 may be positioned on the opposing end of the cooling cavity 254. As fluid may be introduced into the inlet port 286 and removed from the outlet port 288, the fluid removes heat from the first and second power modules 186 and 188 as it communicates over the heat sinks 268 and 270, for providing a substantially equal share of coolant to each power module. In some other embodiments (see e.g., FIG. 17) the inlet port may be positioned substantially midway between the heat sinks 268 and 270 such that coolant may be communicated from the substantially midway point so coolant can flow bidirectionally, over the heat sink 268 in one direction and heat sink 270 in the other direction, and be collected substantially in the middle, for providing substantially equal share of coolant to each power module, with less thermal differential across the power modules.

Electric motors most useful for electric car applications can require alternating current (AC) current. Batteries may supply direct current (DC), so it can be necessary to use an inverter to transform battery supplied DC current into electric motor usable AC current. Additionally, modern digitally managed inverters may be sensitive to excessive heat and vibrations. Thus, the inverter is conventionally physically separated/isolated from the electric motor.

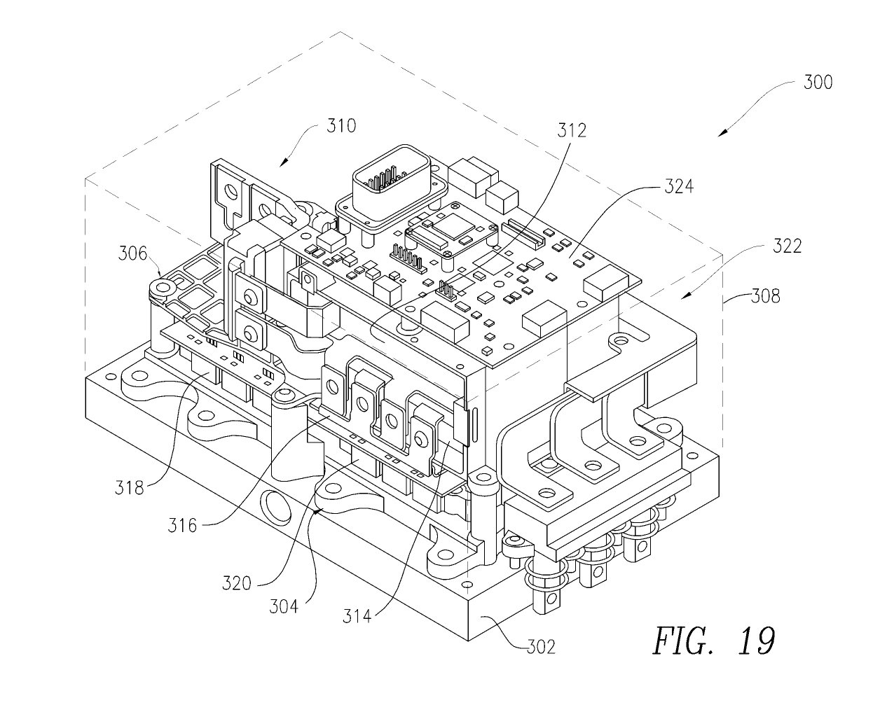

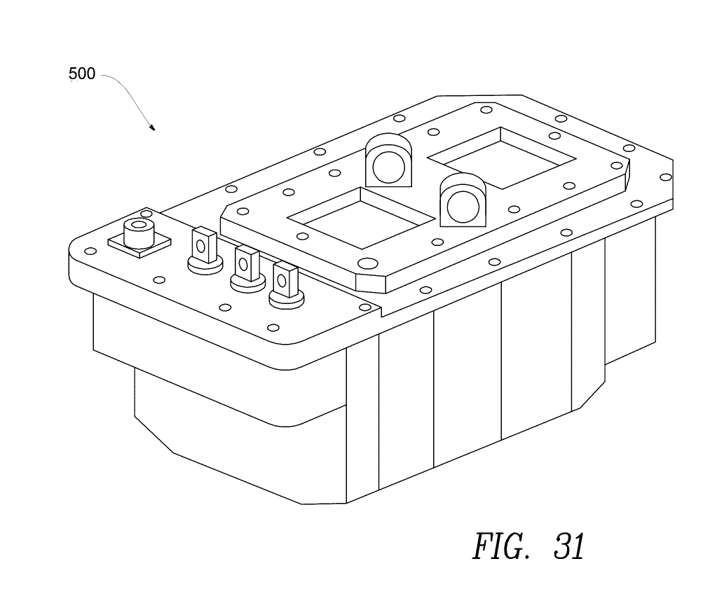

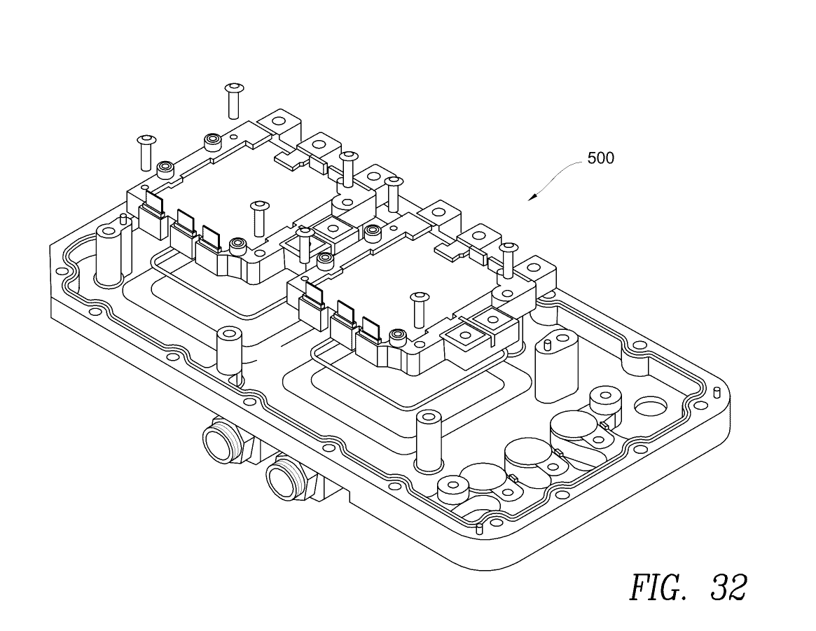

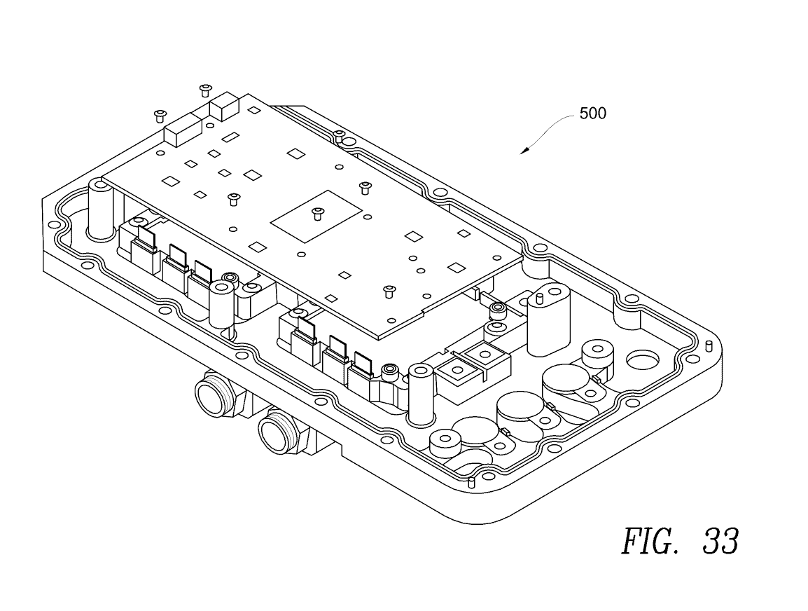

In contrast, disclosed below and with reference to FIGS. 19-35D, an exemplary inverter assembly according to various embodiments is provided, which is customized for packaging into an internal housing of an electric motor (e.g., of an electric car). This placement can minimize current and voltage losses over an extended cable/wire length. According to various embodiments, the inverter assemblies, disclosed below and with reference to FIGS. 19-35D, additionally utilize a conductive metal structure, such as an aluminum structure, which provides greater strength (e.g., structural rigidity) than traditional plastic housings.

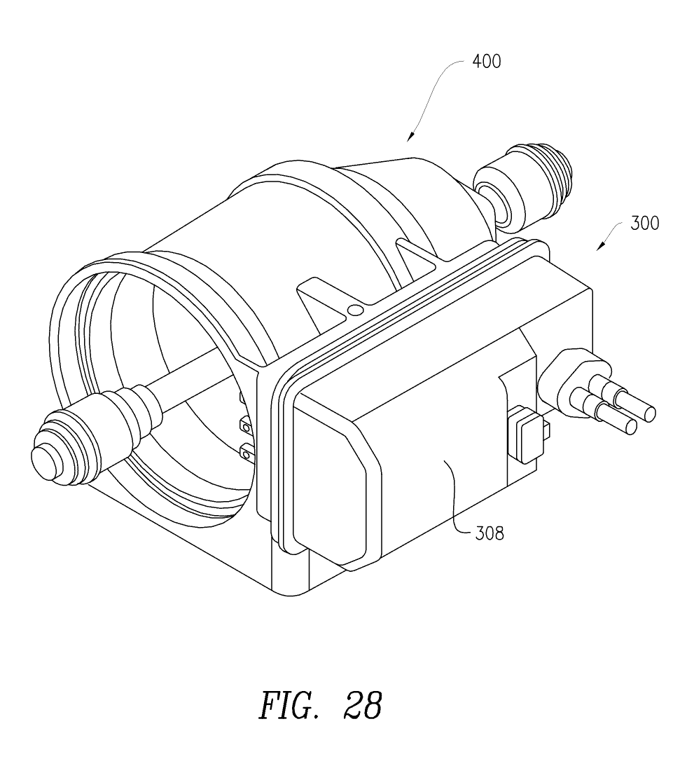

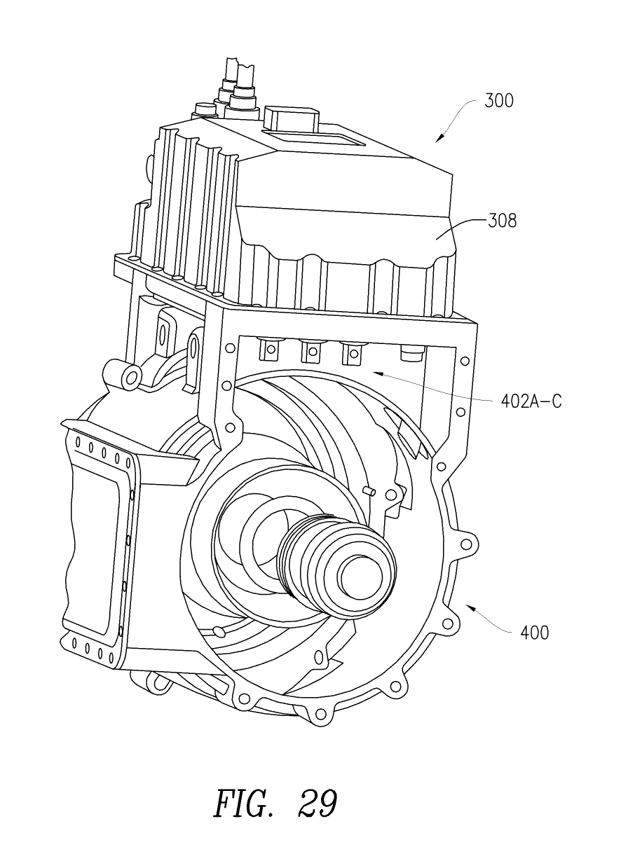

This disclosure presents an inverter assembly (e.g., inverter assembly 300 described in further detail below in relation to FIGS. 19-35D) configured so that it may be attached directly to a motor assembly of the drive train (e.g., of the electric car), as illustrated in FIGS. 28 and 29. In some exemplary embodiments, the inverter assembly's structural elements are manufactured from a thermally and/or electrically conductive metal such as iron, steel, copper, chromium, aluminum, or other materials including alloys. Some embodiments have a conductive metal structure that can provide both protection from external damage (e.g., from an environment outside of the conductive metal enclosure, such as materials that intrude into an engine compartment of an electric car) and electromagnetic interference (EMI) shielding for the sensitive capacitors, controller, circuit board(s), and the like. For example, the electric motor (e.g., of the electric car) can be a source of EMI which can produce undesirable effects in electrical components, such as those of the inverter assembly. Additionally, some embodiments have a conductive metal structure that can provide a solid base/support for connecting the inverter assembly firmly to the motor assembly (e.g., of the electric car). Additionally, in exemplary embodiments, the inverter assembly's structural elements are manufactured from an aluminum alloy selected to provide strength and structural rigidity for inverter assembly 300 and also to save weight.

In some embodiments, the conductive metal enclosure provides significant thermal benefits by transferring heat away from sensitive electronic parts. For example, the conductive metal enclosure can have a thermal conductivity on the order of at least 30 W/(m·K). In some embodiments, the conductive metal enclosure can have a thermal conductivity on the order of at least 200 W/(m·K). Furthermore, a conductive metal used to form the structure can be used to ground mounted control boards. For example, the conductive metal enclosure can have an electrical resistivity on the order of at most 200 nΩm. In some embodiments, the conductive metal enclosure can have an electrical resistivity on the order of at most 50 nΩm. These and other advantages of the following inverter assemblies are provided below with reference to the collective drawings.

In FIG. 19, an inverter assembly 300 and a bottom portion 302 are illustrated. The inverter assembly 300 comprises one or more structural components. In some embodiments, inverter assembly 300 is a single structural piece. In another embodiment, inverter assembly 300 comprises several distinct structural components including a first structural portion 304 and a second structural portion 306. The inverter assembly 300 is shown along with the bottom portion 302. In some embodiments, the bottom portion 302 may be the bottom of a motor housing to which the inverter assembly connects. Various embodiments of the inverter assembly 300 can be housed with an outer housing 308, including a cover (see FIGS. 28 and 29 for best illustrations).

In various embodiments, the inverter assembly 300 also generally includes a DC input filter 310, a first DC link capacitor 312, a second DC link capacitor 314, a DC link bus bar 316, a pair of power modules 318 and 320 (e.g., including IGBT modules like those described above), a three phase AC bus bar 322, and a control circuit board 324.

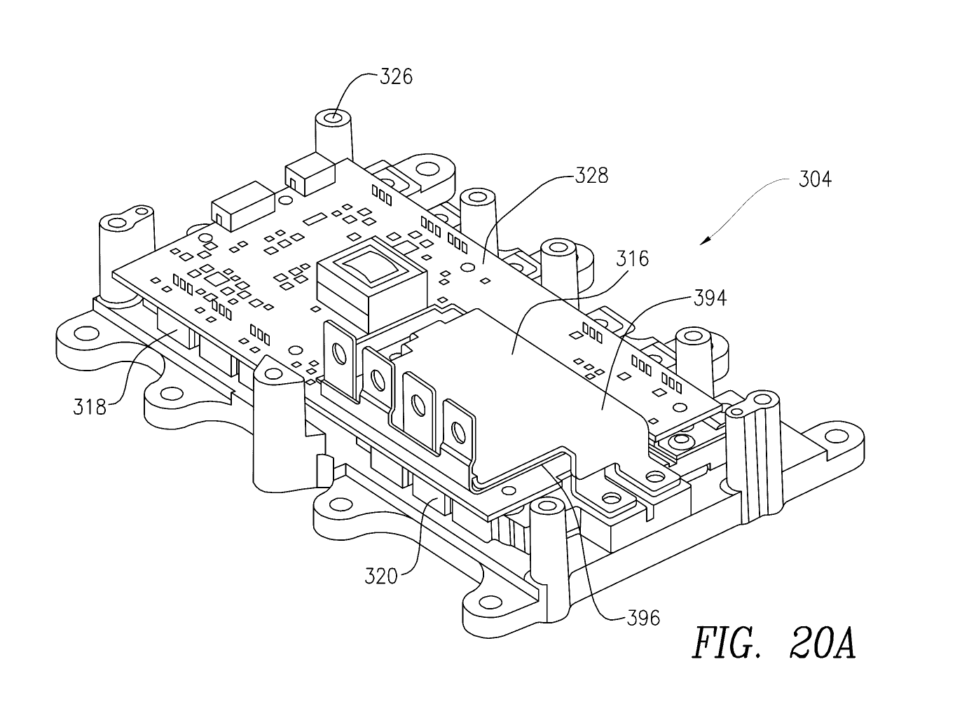

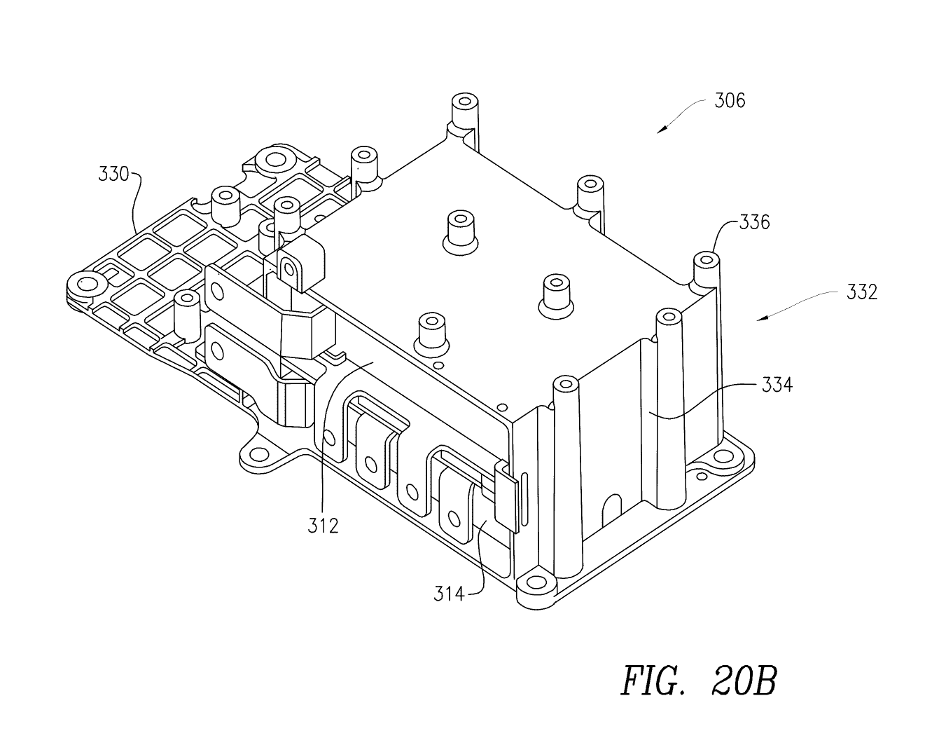

FIG. 20A illustrates the first structural portion 304 that may comprise a plurality of columns, such as columns 326 that are spaced around the periphery of a power module control board 328. A power module control board 328 electrically may couple with the pair of power modules 318 and 320. The DC link bus bar 316 can be mounted onto the power module control board 328.

In the example in FIG. 20B, the second structural portion 306 can mount to the plurality of columns of the first structural portion 304. The second structural portion 306 may comprise a base plate 330 that supports a capacitor housing 332. In some embodiments, the capacitor housing 332 receives the first DC link capacitor 312 and the second DC link capacitor 314. Each of the various capacitors in the second structural portion 306 can be enclosed in a protective epoxy or the like. The capacitor housing 332 can have a sidewall 334 that also may be fabricated from a conductive metal. In some embodiments, the second structural portion 306 may be constructed from a conductive metal which is similar to, or identical to, the conductive metal used for the first structural portion 304.

In some embodiments, the capacitor housing 332 comprises a plurality of columns such as column 336, which can be configured to couple with the control circuit board 324. That is, the control circuit board 324 can be fastened to the capacitor housing 332 using the plurality of columns.

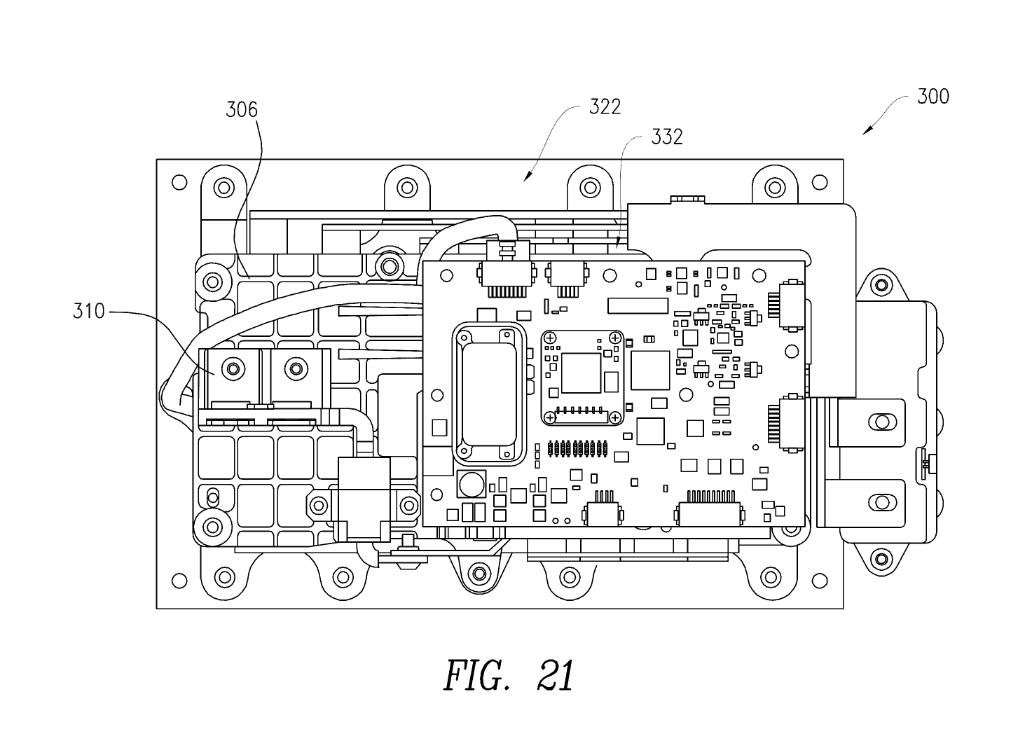

FIG. 21 illustrates a top plan view of the example inverter assembly 300 (the cover and the outer housing not shown in order to illustrate the various elements). In this example, the DC input filter 310 is shown mounted onto the second structural portion 306 (see FIG. 20B). The three phase AC bus bar 322 is illustrated as being wrapped around the capacitor housing 332.

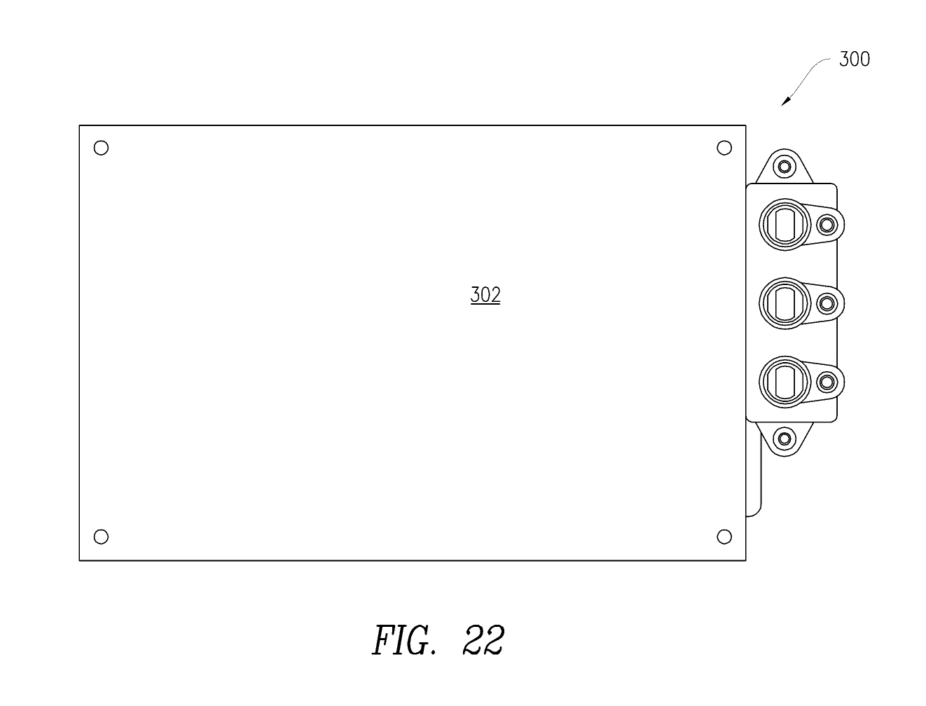

FIG. 22 illustrates a bottom plan view of the example inverter assembly 300 illustrated in FIG. 19, according to various embodiments.

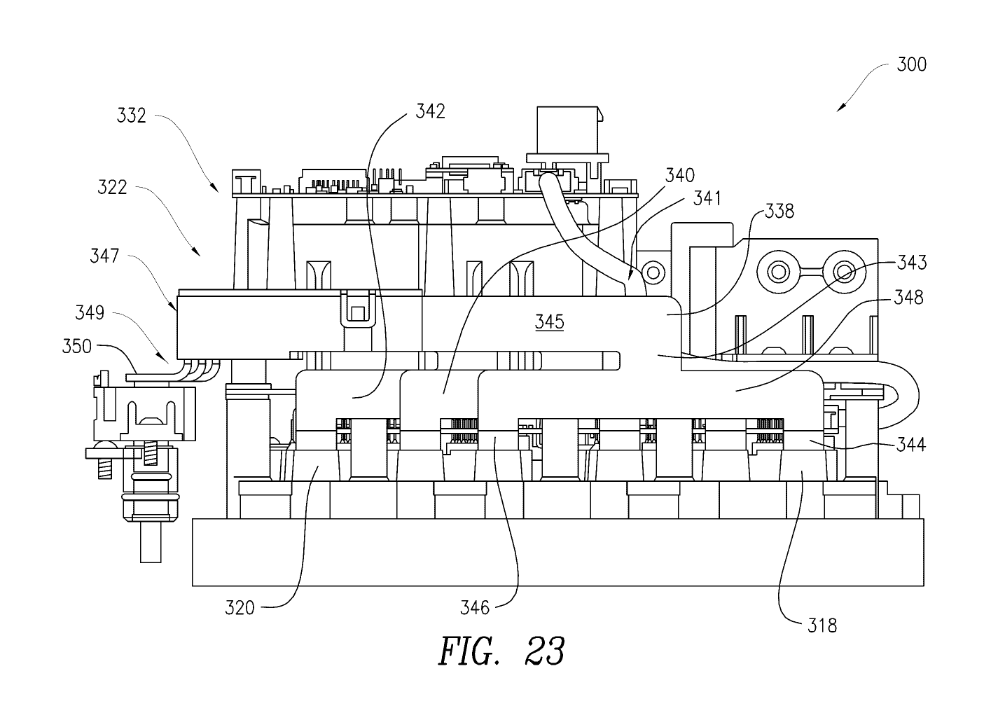

FIG. 23 illustrates the exemplary three phase AC bus bar 322 that can comprise a first bus bar 338, a second bus bar 340, and a third bus bar 342. The first, second, and third bus bars (338, 340, and 342, respectively) can be oriented and mounted in symmetry with one another. The first bus bar 338 can comprise a pair of input tabs 344 and 346. The input tab 344 may couple with power module 318 and the input tab 346 may couple with the power module 320. In this example, the pair of input tabs 344 and 346 extend normally to a bus bar body 348. The first bus bar 338 can comprise an output connector portion 341 that may be comprised of an upward extending section 343 and a second section 345 that transitions to a third section 347 that can extend at a right angle to the second section 345. In some embodiments, the third section 347 may transition to a downward section 349 that terminates with an output tab 350.

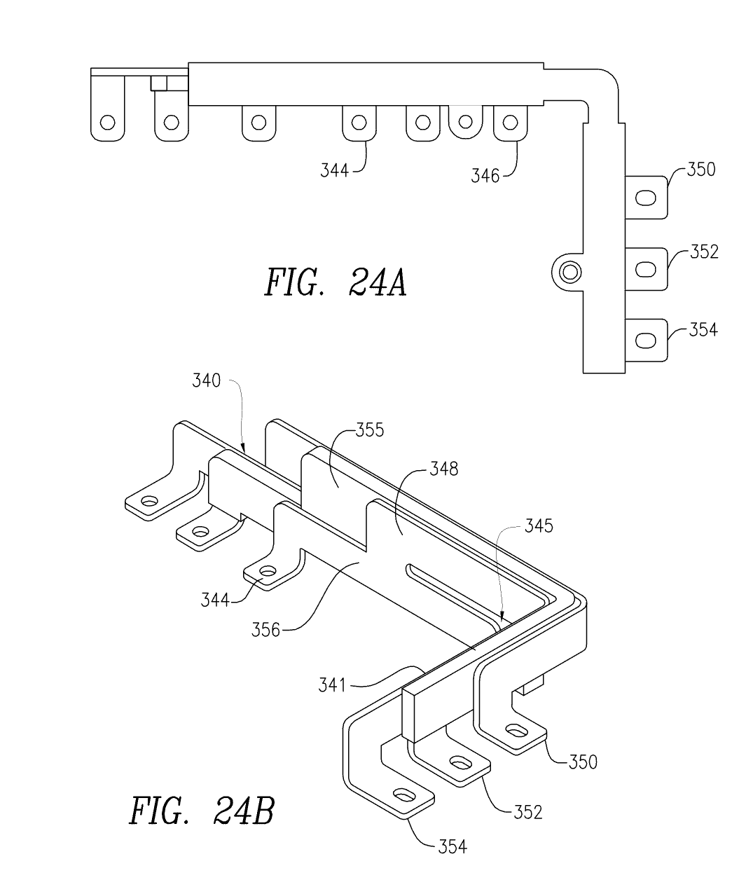

The second bus bar 340 and the third bus bar 342 may be constructed similarly to the first bus bar 338 with the exception that an output tab 352 (see FIG. 24) of the second bus bar 340 may be longer than the output tab 350 of the first bus bar 338.

According to some embodiments, the three phase AC bus bar 322 wraps around the capacitor housing 332 such that the plurality of input tabs of the three bus bars 338, 340, and 342 are oriented on one side of the capacitor housing 332 and the output tabs of the three bus bars 338, 340, and 342 are oriented on an adjacent side of the capacitor housing 332.

In addition to illustrating the exemplary three AC bus bars 338, 340, and 342 in FIG. 23, various aspects of the spacing and orientation of the three AC bus bars 338, 340, and 342 are also shown in the top view of FIG. 21 and in the perspective view in FIG. 19. As depicted variously in the examples of FIGS. 19, 21, 23, 25, the first bus bar 338 is located farthest from the capacitor housing 332. The second bus bar 340 is located in between the first bus bar 338 and the third bus bar 342. Thus, the first, second, and third bus bars (338, 340, and 342, respectively) are arranged in a spaced but nested configuration. In one embodiment, an insulating material can be placed between adjacent bus bars to prevent contact therebetween. As with other embodiments, the bus bars 338, 340, and 342 can also be coated with an insulating material.

As illustrated in FIGS. 24A and 24B, the bus bar body 348 of the first bus bar 338 can comprise a front surface 356. The input tabs 344 and 346 extend behind the front surface 356. The output connector portion 341 (see FIG. 23) may be bent at a right angle such that the second section 345 can also extend behind the front surface 356. This exemplary configuration of the first bus bar 338 can allow for the output connector portion 341 (see FIG. 23) to wrap around the capacitor housing 332.

To be sure, the second and third bus bars (340 and 342, respectively) each may comprise input tabs, a bus bar body and an output connector.

In some embodiments, an output tab 354 of the third bus bar 342 is longer than both the output tab 352 of the second bus bar 340 and the output tab 350 of the first bus bar 338. This discrepancy in the lengths of the output tabs 350, 352, and 354 can allow for symmetry and alignment of the output tabs relative to one another.

In other embodiments, the second bus bar 340, and specifically the bus bar body is covered with an insulating cover 355. The insulating cover 355 spaces the first, second, and third bus bars (338, 340, and 342, respectively) apart from one another, allowing for signal isolation and prevention of short circuits across the bus bars 338, 340, and 342.

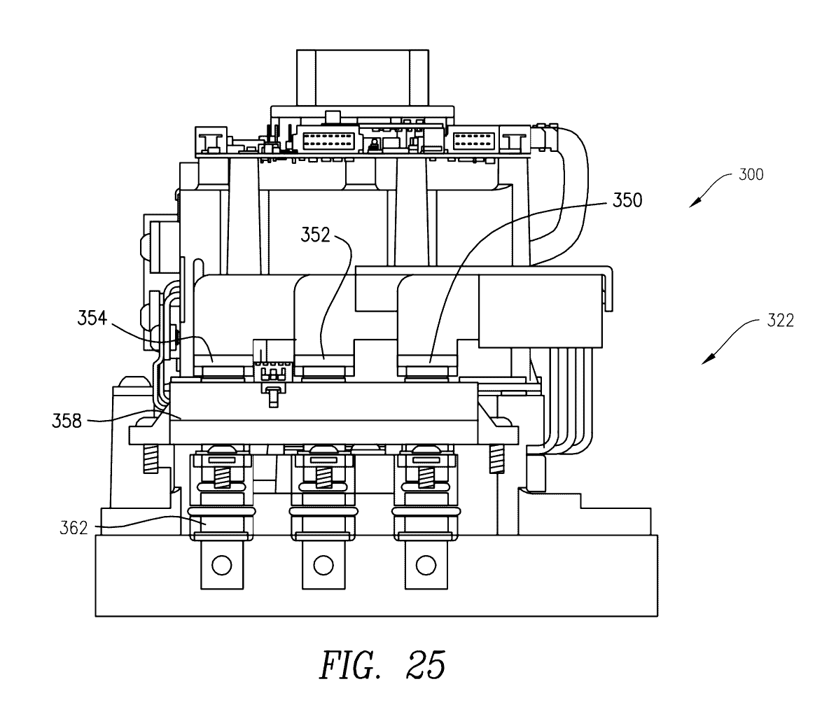

FIG. 25 is a rear elevation view of the example inverter assembly 300. In the example in FIG. 25, a current sensor 358 is provided for sensing the AC current for each of the output tabs 350, 352, and 354 of the three phase AC bus bar 322.

Bus rods 362 couple the three phase AC output of the inverter assembly 300 to an AC electric motor. In some embodiments, bus rods 362 are solid rods composed of a conductive metal, e.g., zinc, copper, aluminum, silver, or other suitable material including alloys. For example, bus rods 362 provide lower power loss and higher reliability than, for example, power cables.

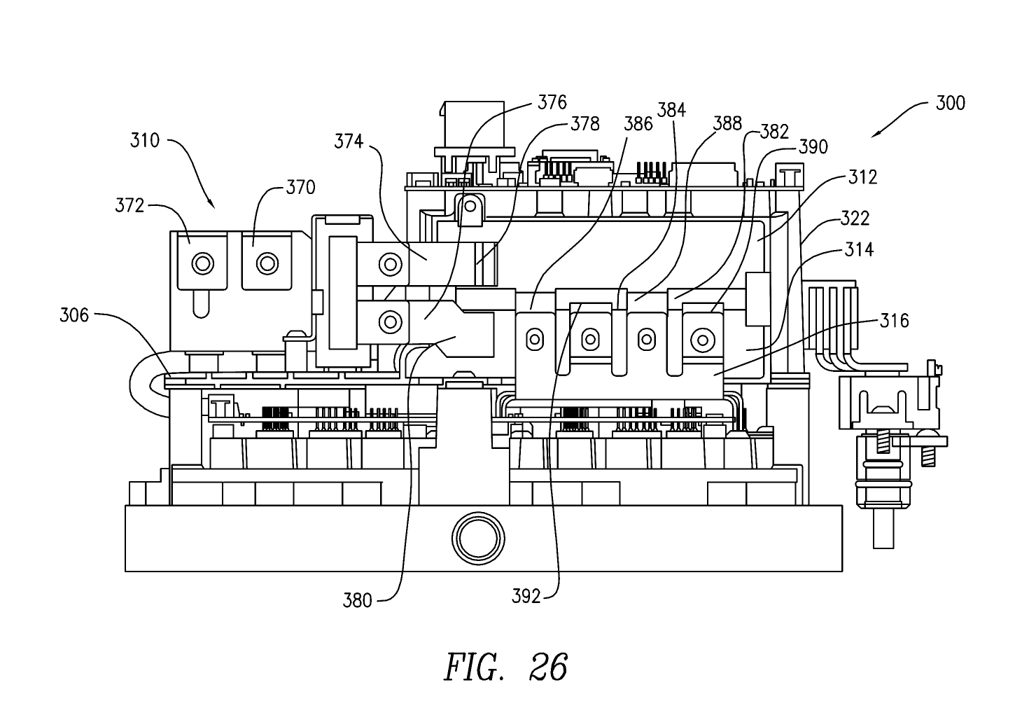

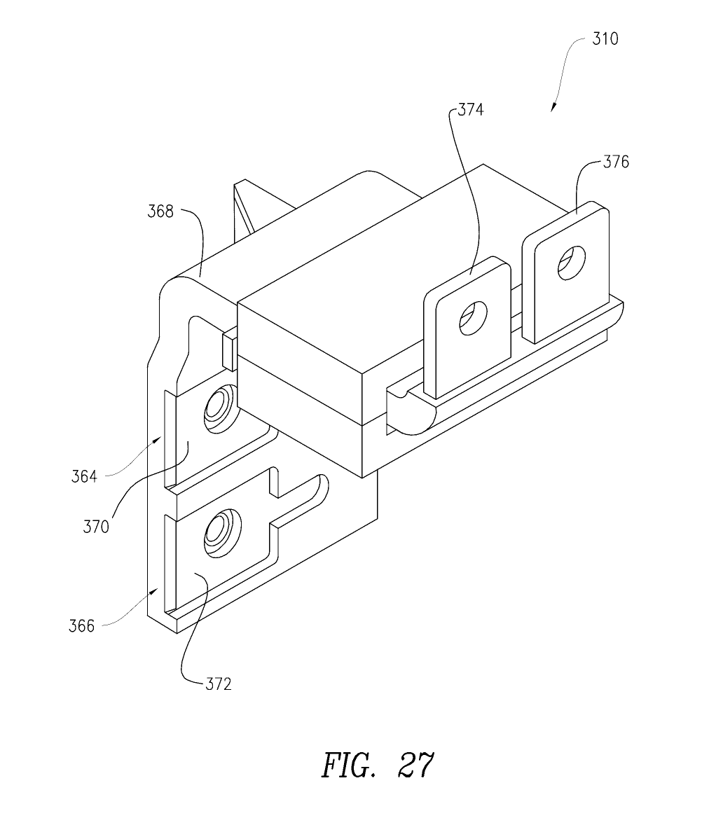

FIG. 26 is a side elevation view of the example inverter assembly 300, illustrating an opposing side relative to FIG. 23. The example in FIG. 26 shows the DC input filter 310, the first DC link capacitor 312, the second DC link capacitor 314, and the DC link bus bar 316 of the exemplary inverter assembly 300, according to various embodiments.

FIG. 27 is a perspective view that illustrates greater detail of the exemplary DC input filter 310. The DC input filter 310 may comprise a positive connector 364 and a negative connector 366. In this example, the positive connector 364 and the negative connector 366 are nested together and can be covered with an insulating housing 368. Notches in the insulating housing 368 can expose a positive input tab 370 and a negative input tab 372, as well as a positive output tab 374 and a negative output tab 376.

Referring back to the example in FIG. 26, the DC input filter 310 can be mounted onto the second structural portion 306 in such a way that the negative input tab 372 can be disposed near the outer periphery of the inverter assembly 300. The negative input tab 372 and the positive input tab 370 may be oriented to point upwardly.

In various embodiments, the shape of the DC input filter 310 can allow for the positive output tab 374 and the negative output tab 376 to wrap around the capacitor housing 332 (see FIGS. 20B and 23) when the DC input filter 310 is mounted onto the second structural portion 306.

The positive output tab 374 and the negative output tab 376 can be electrically coupled with connectors of the first DC link capacitor 312 and the second DC link capacitor 314, respectively. For example, the first DC link capacitor 312 can include a first connector 378 and the second DC link capacitor 314 can comprise a second connector 380. The first connector 378 can be formed directly into the first DC link capacitor 312. The second connector 380 can also be formed directly into the second DC link capacitor 314.

In some embodiments, the first DC link capacitor 312 and the second DC link capacitor 314 are potted into the capacitor housing 332 such that they form a side of the capacitor housing 332. The first DC link capacitor 312 can be located above the second DC link capacitor 314 in some embodiments.

Referring to FIG. 26, according to some embodiments, the first DC link capacitor 312 comprises an output connector bar 382 and the second DC link capacitor 314 can comprise an output connector bar 384. The output connector bars 382 and 384 can have complimentary sawtooth configurations that mate together to form a spacer that divides the first DC link capacitor 312 from the second DC link capacitor 314. In some embodiments, the output connector bar 382 may comprise a pair of positive output tabs 386 and 388, while the output connector bar 384 may comprise a pair of negative output tabs 390 and 392 (see also FIG. 19).

Referring to FIGS. 26 and 20A, the pair of positive output tabs 386 and 388 and the pair of negative output tabs 390 and 392 can be used to electrically couple the first DC link capacitor 312 and the second DC link capacitor 314 with the DC link bus bar 316. In some embodiments, the DC link bus bar 316 has a positive bus bar 394 and a negative bus bar 396. The positive bus bar 394 and the negative bus bar 396 can be placed into a nested, but spaced apart relationship with one another. The DC link bus bar 316 may then be electrically coupled with the power modules 318 and 320, in some embodiments.

In some embodiments, the DC link bus bar 316 is positioned below the second structural portion 306 such that the DC link bus bar 316 is between the second portion 306 and the power modules 318 and 320.

FIG. 28 illustrates the inverter assembly 300 and the outer housing 308 of FIG. 19 in combination with a motor housing 400. The motor housing 400 will house components of an electric motor that is powered by the inverter assembly 300. The connector cables that provide power into the DC bus bar are illustrated.

FIG. 29 illustrates solid rod connections 402A-C, which are associated with output tabs of the three phase AC bus bar. In some embodiments, solid rod connections 402A-C are solid rods composed of a conductive metal, such as zinc, copper, aluminum, silver, or other suitable material including alloys. For example, solid rod connections 402A-C can provide lower power loss and higher reliability than, for example, power cables. Solid rod connections 402A-C can extend from the housing 308 to the inverter assembly 300 for connection with an electric motor power input within the motor housing 400.

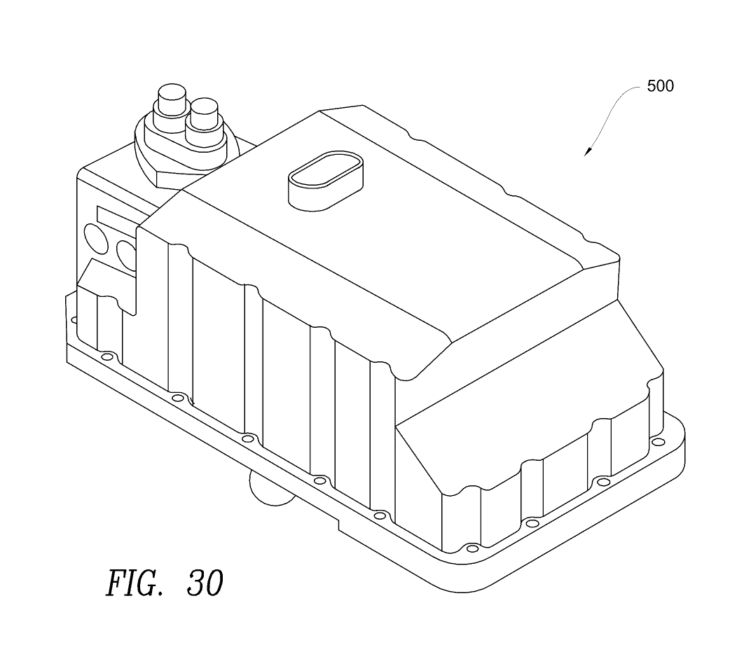

FIGS. 30-33 collectively illustrate various views of an example inverter assembly 500. The inverter assembly 500 includes a compact, three dimensionally printed housing, in some embodiments. The inverter assembly 500 comprises a unique housing and cover configuration that enhances integration with a powertrain, as well as integration within a motor assembly.

The inverter assembly 500 is configured similarly to the embodiments above and with the addition of a cooling assembly, as in the embodiments of FIGS. 17-18C with input and output ports disposed below the power modules.

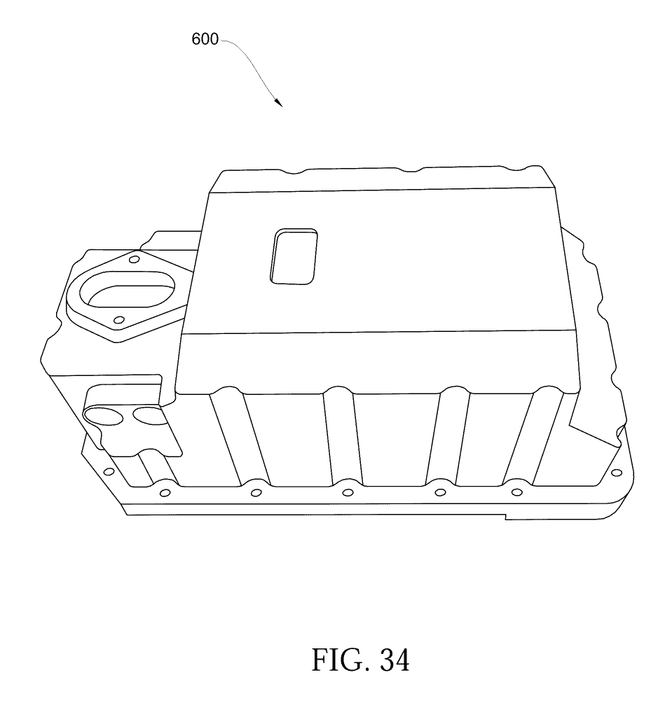

The embodiment of FIG. 34 illustrates a perspective view of an example inverter assembly 600 having an alternative housing and cover configuration that enhances integration with a powertrain, as well as integration within a motor assembly.

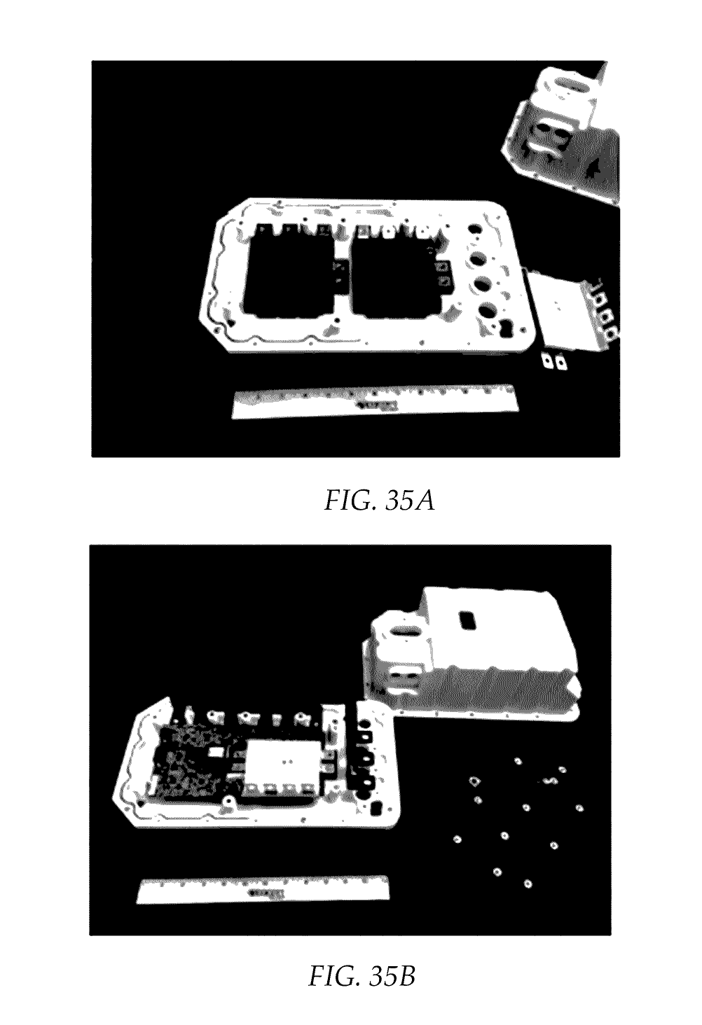

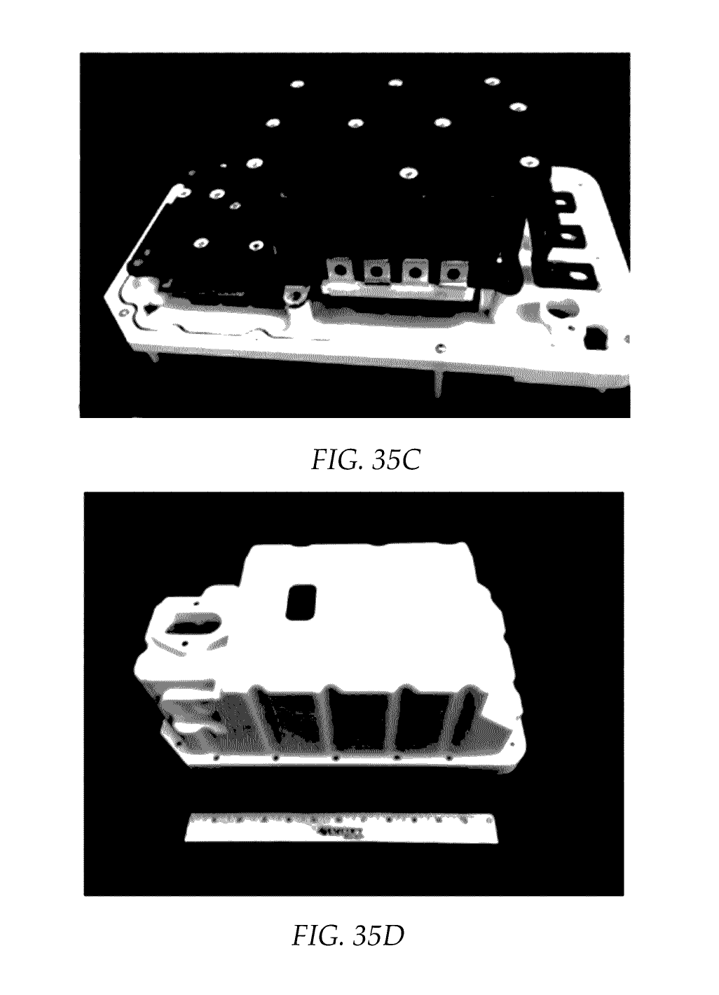

A manufacturing process for assembling an example inverter assembly is illustrated collectively in FIGS. 35A-D. In FIG. 35A, power modules are mounted to a cooling assembly substrate. In FIG. 35B, a gate driver and bus bars are added to the assembly. In FIG. 35C, a capacitor assembly is mounted and connected to the gate driver and bus bars. In FIG. 35D, a cover (see also FIG. 34) is installed to complete the assembly.

While the embodiments recited above describe the use of the inverter assembly with a three phase AC power system, the techniques described herein are not limited to three phase AC applications. It will be recognized by one of ordinary skill in the art that the techniques described herein may be adapted to other types of AC power systems. For example, embodiments of the techniques set out in this disclosure may additionally or alternatively utilize single phase, two phase, three phase, . . . or n-phase AC power systems.

It will be understood that the various embodiments described herein are not limiting in their configurations and that one of ordinary skill in the art with the present disclosure before them will recognize that features of embodiments can be eliminated, interchanged, or combined if desired.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. An inverter assembly comprising:
a conductive metal structure connecting the inverter assembly to a motor assembly, containing an inverter, physically protecting the inverter from an external environment, shielding at least some components of the inverter from electromagnetic interference, and providing an electrical ground to one or more components of the inverter; and
the inverter comprising:
a first DC link capacitor;
a second DC link capacitor;
a capacitor enclosure, the first DC link capacitor and the second DC link capacitor being potted on a sidewall of the capacitor enclosure;
a plurality of power modules electrically coupled with the both the first DC link capacitor and the second DC link capacitor; and
an AC bus bar assembly coupled to the plurality of power modules, the AC bus bar assembly providing output current produced by the plurality of power modules.

2. The inverter assembly of claim 1, wherein the AC bus bar assembly comprises three bus bars that each comprise:
a bus bar body;
a plurality of input tabs that extend normally to the bus bar body; and
an output connector comprising an upward extending section, a second section that transitions to a third section that extends at a right angle to the second section, the third section transitioning to a downward section that terminates with an output tab.

3. The inverter assembly of claim 2, wherein the AC bus bar assembly wraps around the capacitor enclosure such that the plurality of input tabs of the three bus bars are oriented on one side of the capacitor enclosure and the output tabs of the three bus bars are oriented on an adjacent side of the capacitor enclosure.

4. The inverter assembly of claim 2 further comprising bus rods for electrically coupling each of the output tabs of the three bus bars to the motor assembly.

5. The inverter assembly of claim 1 further comprising a direct current (DC) input filter, the DC input filter being substantially L-shaped, having positive and negative output tabs angled around the sidewall of the capacitor enclosure, and being electrically coupled with both the first DC link capacitor and the second DC link capacitor.

6. The inverter assembly of claim 5, wherein positive and negative input tabs of the DC input filter are arranged at a right angle relative to the positive and negative output tabs of the DC input filter.

7. The inverter assembly of claim 1, wherein the first DC link capacitor comprises a first input tab that is embedded into the first DC link capacitor and the second DC link capacitor comprises a second input tab that is embedded into the second DC link capacitor.

8. The inverter assembly of claim 1, wherein the first DC link capacitor and the second DC link capacitor each comprise an insulating coating.

9. The inverter assembly of claim 1, wherein:
the plurality of power modules mount to a first portion that comprises a plurality of columns, and
the plurality of columns comprise an aluminum alloy.

10. The inverter assembly of claim 9, wherein the capacitor enclosure is mounted to a second portion that couples with the plurality of columns of the first portion.

11. The inverter assembly of claim 10, wherein a positive bus bar and a negative bus bar are nested together and located between the capacitor enclosure and the plurality of power modules.

12. The inverter assembly of claim 1 further comprising a controller circuit board mounted to a top of the capacitor enclosure.

13. The inverter assembly of claim 2, wherein:
the bus bar body comprises a front surface, and
the plurality of input tabs extend in a first direction from the front surface and the third section extends in the first direction relative to the front surface.

14. The inverter assembly of claim 2, wherein the output tab of the output connector is oriented at a right angle relative to the plurality of input tabs.

15. The inverter assembly of claim 2 further comprising first, second, and third bus bars, wherein the second bus bar is disposed between the first bus bar and the third bus bar, the second bus bar being spaced apart from the first bus bar and the third bus bar being spaced apart from the second bus bar.

16. The inverter assembly of claim 2, wherein a number of the plurality of power modules is two.

17. The inverter assembly of claim 16, wherein each of the three bus bars is electrically coupled to both of the power modules, the output connectors of the three bus bars being coplanar with one another.

18. The inverter assembly of claim 2, wherein the right angle between the second section and the third section of the output connector is such that the three phase output AC bus bar assembly wraps around a rectangular capacitor enclosure to which the three phase output AC bus bar assembly is coupled.

19. An inverter assembly comprising:
a housing, the housing comprising an aluminum alloy, connecting the inverter assembly to a motor assembly, enclosing an inverter, physically protecting the inverter from an external environment, shielding at least some components of the inverter from electromagnetic interference, and providing an electrical ground to one or more components of the inverter; and
the inverter comprising:
a direct current (DC) input filter;
first and second DC link capacitors coupled respectively with a positive and a negative terminal of the DC input filter;
a capacitor enclosure, the first DC link capacitor and the second DC link capacitor being potted on a sidewall of the capacitor enclosure;
the DC input filter being substantially L-shaped and having positive and negative output tabs angled around the sidewall of the capacitor enclosure;
a controller circuit board mounted to a top of the capacitor enclosure;
first and second DC link capacitor output bus bars, each comprising a pair of output tabs;
a DC link bus bar assembly comprising a positive bus bar and a negative bus bar, each of the positive and the negative bus bars being coupled with one of the pair of output tabs of the first DC link capacitor output bus bar and one of the pair of output tabs of the second DC link capacitor output bus bar;
two power modules electrically coupled with the DC link bus bar assembly; and
a three phase output AC bus bar assembly coupled to the two power modules, the three phase output AC bus bar assembly providing three unique phases of output current produced by the two power modules.

20. An inverter assembly comprising:
a housing comprising an aluminum alloy, connecting the inverter assembly to a motor assembly, enclosing an inverter, physically protecting the inverter from an external environment, shielding at least some components of the inverter from electromagnetic interference, and providing an electrical ground to one or more components of the inverter; and
the inverter comprising:
a direct current (DC) input filter;
first and second DC link capacitors coupled respectively with a positive and a negative terminal of the DC input filter;
a capacitor enclosure, the first DC link capacitor and the second DC link capacitor being potted on a sidewall of the capacitor enclosure,
the DC input filter being substantially L-shaped having positive and negative output tabs angled around the sidewall of the capacitor enclosure;
a controller circuit board mounted to a top of the capacitor enclosure;
first and second DC link capacitor output bus bars, each comprising a pair of output tabs;
a DC link bus bar assembly comprising a positive bus bar and a negative bus bar, each coupled with one of the pair of output tabs of the first DC link capacitor output bus bar and one of the pair of output tabs of the second DC link capacitor output bus bar;
a pair of power modules electrically coupled with the DC link bus bar assembly; and
a three phase output AC bus bar assembly being coupled to the pair of power modules, providing three unique phases of output current produced by the pair of power modules, and comprising three bus bars, wherein:
each of the three bus bars is electrically coupled to both of the power modules of the pair of power modules, and
the three phase output AC bus bar assembly wraps around the capacitor enclosure such that input tabs of the three bus bars are oriented on one side of the capacitor enclosure and output tabs of the three bus bars are oriented on an adjacent side of the capacitor enclosure.
